(19) United States
(12) Patent Application Publication
(10) Pub. No.: US 2018/0158080 A1
(43) Pub. Date: Jun. 7, 2018

(54) INTERACTIVE DISPLAY SYSTEM

(71) Applicant: Brad Mehl, Livingston, NJ (US)

(72) Inventor: Brad Mehl, Livingston, NJ (US)

(21) Appl. No.: 15/367,609

(22) Filed: Dec. 2, 2016

(51) Int. Cl. G06Q 30/02

(52) U.S. Cl. CPC G06Q 30/0203; H04W 88/16

(57) ABSTRACT

A digital engagement and analytics system coordinates on-screen display of user input from a plurality of computing devices distributed across a communication network. A distributed computing platform is described to provide visual interactivity to users of the system, and to collect qualitative data, demographic data and contact information, and other data on users. Multi-dimensional rendering of user data objects with customizable visualizations are provided.

### BACKGROUND

Over the past twenty years, the way people communicate and interact with information has shifted from one way to “many to many” due to the internet, and supporting technologies. But this kind of group interactivity has generally not spilled over to the offline world at in-person settings. In person communication is still largely one way, whether the goal is to inform, persuade, promote, teach, or entertain. But all of these settings have screens with potential for audience interactivity.

Events conducted in the past with a simple lectern can now take advantage of 4K projectors and high-res displays than have breached the 100″ threshold. Handheld projectors available from more than a dozen companies. The ubiquity of presentation software like Microsoft PowerPoint and Apple Keynote have imposed—for better or for worse—a textual and visual element into the majority of presentations.

At trade shows and business conferences, participants showcase goods, preview upcoming ad campaigns, participate in industry panel discussions and the like—and typically rely on screens to convey information. At these events, the focus may be on communicating a certain corporate philosophy and highlighting accomplishments, but also soliciting feedback. Sales meetings are but one more example where information is given, but audience feedback are sought.

By some industry estimates, over 200 million people annually attend 1.8 million of these events in the U.S. alone.

Beyond the corporate world, events are hosted every day at universities, high schools, elementary schools, and the like. Countless other venues provide one-way transfer of information or entertainment, but with limited ability for audience participation. Examples include movie theaters, sports stadiums and arenas, bars and restaurants, weddings and parties, inflight entertainment, and the like.

Systems for conducting audience surveys have been tried but suffer significant drawbacks that have limited acceptance. Many of these polling systems have required specialized hardware at the venue to record a user's response. The pads and controllers given to the audience are costly to implement and may be impractical in very large settings. Equipment for conducting the session and receiving user feedback may require setup on the part of the user.

Apps for mobile computing devices have also been attempted to bridge the gap between audience and presenter by enabling communication from a portable device. However, these apps are solitary experiences and do not create group interactivity on a common screen. They also can require a separate download step and require setup, which can minimize participation. Users may be wary of installing apps on their device in a commercial setting, which may further limit involvement.

Social media has also been utilized to include audience feedback. Social media is necessarily limited to specific networks and not all participants may participate in a given network. Social media may further require a specialized hashtag or handle in order to participate that if mis-entered can prevent participation.

Many existing event systems also require complicated setup on the part of the presenter, which can be a distraction from producing the event and limit willingness to incorporate audience feedback into the event.

Some SMS based systems are an improvement, but fall short on visual engagement and therefore participation.

The above examples fail to present the user responses in an engaging manner—whether using visualizations, animations, images, audio, video, or otherwise—to further hold the audience's attention. Many of these systems further fail to provide customization to the event host to visually reinforce the topic, theme or brand of the event, and offer no ability to curate or moderate the user responses.

Further, many of these approaches fail to provide a means for recording user responses and providing reports to event hosts.

What is thus needed is a system and method for that solicits feedback from an audience that is easy for audience members to set up.

What is further needed is a system and method for that solicits feedback from an audience, with minimal or no setup.

What is further needed is a system and method that presents user responses in a curated, visually-engaging manner to increase user attentiveness

What is further needed is a system and method that is customizable and allows event hosts to incorporate images and video into the event.

What is further needed is a system and method that is permits tracking and customized reporting of responses and audience data to determine the effectiveness of an event.

### BRIEF DESCRIPTION OF THE DRAWINGS

The features and advantages of the present disclosure will be more fully understood with reference to the following detailed description when taken in conjunction with the accompanying figures, wherein:

FIG. 1 is a flow diagram showing an exemplary use case for an embodiment of the invention.

FIG. 2 is a functional diagram describing the logical components of an exemplary system.

FIG. 3 is a flowchart describing the steps from message receipt through visualization in embodiments of the invention.

FIG. 4 is a flowchart describing the visualization process in embodiments of the invention.

FIGS. 5a-5d describe a sample queue data structure for storing user message data.

FIGS. 6a-6c are example visualizations used with embodiments of the present invention.

FIGS. 7a-7j contain images of a sample customer portal interface and walkthrough for use with embodiments of the present invention.

FIGS. 8a-8c contain images of a sample reporting portal interface for use with embodiments of the present invention.

### SUMMARY

In embodiments, a system for receiving and displaying enhanced audience commentary or feedback is disclosed. In embodiments, at least one display screen may be configured to display a destination code and a session code, and a communication gateway may be configured to receive at least one user data packet sent to the destination code by one of a plurality of computing devices. In embodiments, an application engine may be coupled to the communication gateway and configured to receive the user data packet, and to perform one more lookups in a remote biographical data source to create a processed data packet. In embodiments, a database may be coupled to the application engine and be configured to store a plurality of processed data packets, each comprising: (a) a unique identifier; (b) user response data; and (c) user biographical data. In embodiments, a visualization engine may be coupled to the database and configured to load the user response data of a processed data packet and coordinate the graphical display of the processed data packet on the display screen.

In embodiments, a computer-implemented method for displaying enhanced audience commentary or feedback is described in which the method includes the steps of: (1) providing a destination code and a session code to at least one user; (2) receiving, from a communication gateway, a user data packet comprising information to be displayed and a user identifier; (3) storing, in a database coupled to the communication gateway, the user data packet; (4) receiving, at an application engine, the user data packet and performing one or more lookups in a remote biographical data source to create a processed data packet; (5) storing the processed data packet in a database coupled to the application engine, said database configured to store a plurality of processed data packets, each comprising: (a) a unique identifier; (b) user response data; and (c) user biographical data; and (5) receiving, at a visualization engine coupled to the database, the user response data associated with a processed data packet and coordinating the graphical display of the processed data packet on the display screen.

In further embodiments, an application engine may be configured to aggregate user response data and user biographical data and generate summary reports, which reports may include: (a) the identity of the party that submitted the user response data; and (b) the content of the user response data. In further embodiments, the summary reports include at least one of characteristic concerning the party that submitted the user response data, the characteristic being selected from the list of: geographic information, demographic information, financial information, and income.

In embodiments, the application engine may be configured to permit the submission of a user data packet without prior registration.

In embodiments, the visualization engine may be further configured to display the user response data in a graphical format, which format may include one of: animation, particle, word cloud, and front-and-center.

In embodiments, a moderation module may be provided and coupled to a visualization engine to permit review of user response data prior to display on the display screen.

In embodiments, the application engine may be further configured to store image data as part of a user data packet for later display on the display screen, which image data may come through the communication gateway or be retrieved by a database lookup on a remote data source.

### DETAILED DESCRIPTION

A digital engagement and analytics tool is disclosed that provides a means for event and other customers to increase attendee engagement by soliciting feedback and then presenting group responses in a visually engaging manner that turns any screen or display seen by many people into an interactive group experience. A distributed computing platform is described to provide visual interactivity to users of the system, and to collect qualitative data, demographic data and contact information, and other data on users.

In embodiments, the system of the present invention may provide to a user operating a mobile computing device, a means to interact with a live presentation, by submitting responses, commentary answers, and the like, as part of a collective group experience. Responses from event participants may be displayed on a screen at the event.

Participant submissions may be recorded, along with user data, to generate rich information sources for customers to measure effectiveness.

In embodiments, a system is provided for receiving and identifying user comments, and aggregating user information, at an event without dedicated application download or registration.

In embodiments, a system is provided for multi-dimensional rendering of audience comments with visualizations that are highly customizable”

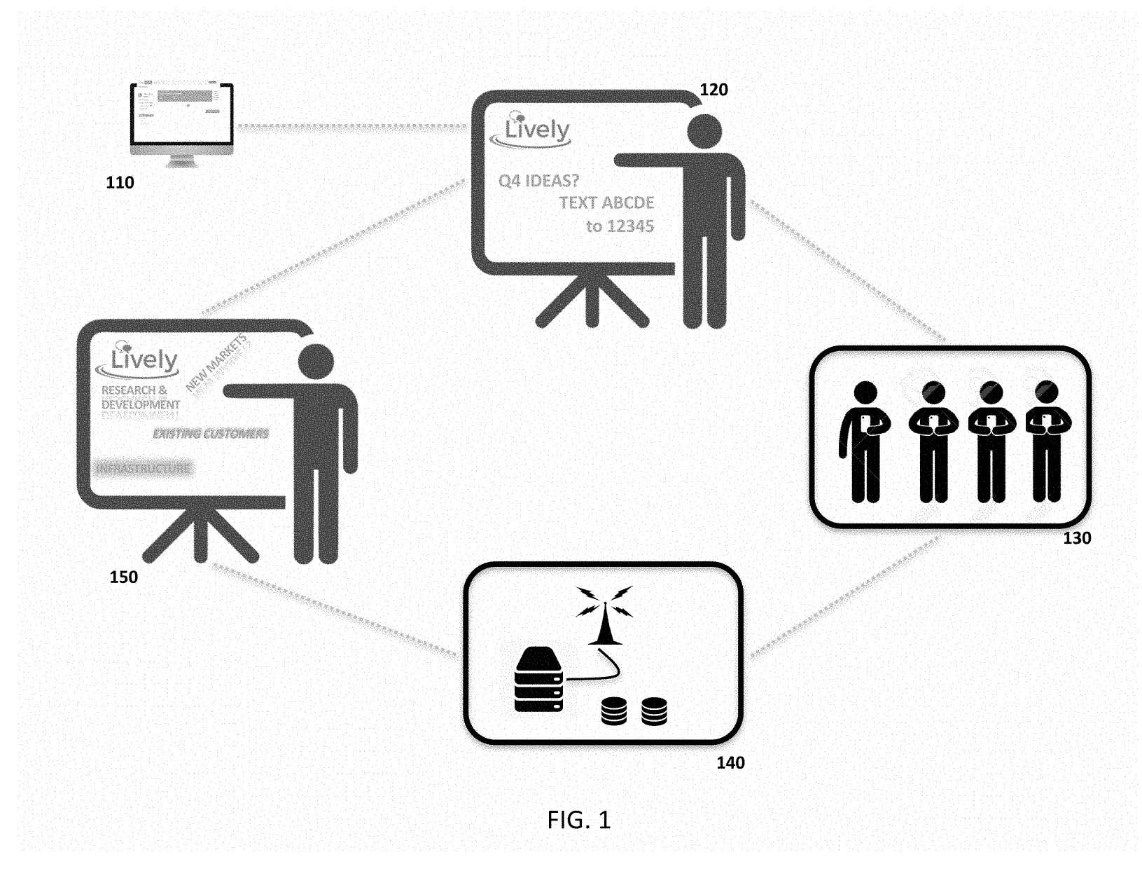

Referring to FIG. 1, a simple use case of an embodiment of the invention is shown. The organizer of the presentation, who may also be known as the customer, may initiate a session by logging in to a secure web-based portal 110 that provides various options for conducting the session, including the means by which users may interact, the questions to be asked, visualizations and user experience, moderation level, reporting, and the like. Once these options have been set, a communication link may be set that can be provided to audience participants.

In a preferred embodiment, and as shown in FIG. 1, a communication link is a unique session code (“ABCDE”) and an SMS short code (“12345”) to which the session code may be sent via text message. A customer or organizer may present (120) this information to the audience, and the audience may then engage (130) the system by communicating in the designated manner.

In embodiments, session and short code customization may be provided. For example, customers may select a unique session code of their own choosing instead of the assigned alphanumeric identifier. Session codes can comprise brand names so that at an Amazon shareholder meeting, shareholders could be prompted to text “AMAZON” to a unique SMS short code. Attendees at a political rally could be prompted to text the candidate's last name to the short code, while students in a class could use the name of their teacher. The variations on this them are limitless and the system can be highly customized to meet individual needs.

In the example of FIG. 1, the presenter is soliciting (120) ideas for “Q4” and has provided a means for engagement to the users in the audience. Once an audience member engages the system by sending the session code in the body of a text message to the designated number, all further text messages to that number may be submitted to the system as comments, poll responses, or whatever the customer has configured.

Messages sent (130) by the participants may be received by the system (140), which comprises various customized components including a communication gateway, application server, databases, content and system databases, and a visualization engine, among others. The incoming user data is processed, filtered, associated with media, and other functions, before being presented (150) at the event. The content may be visualized in any number of formats, which are visually engaging and highly customizable. The customer is thus able to engage the audience in an interactive, exciting, and engaging manner.

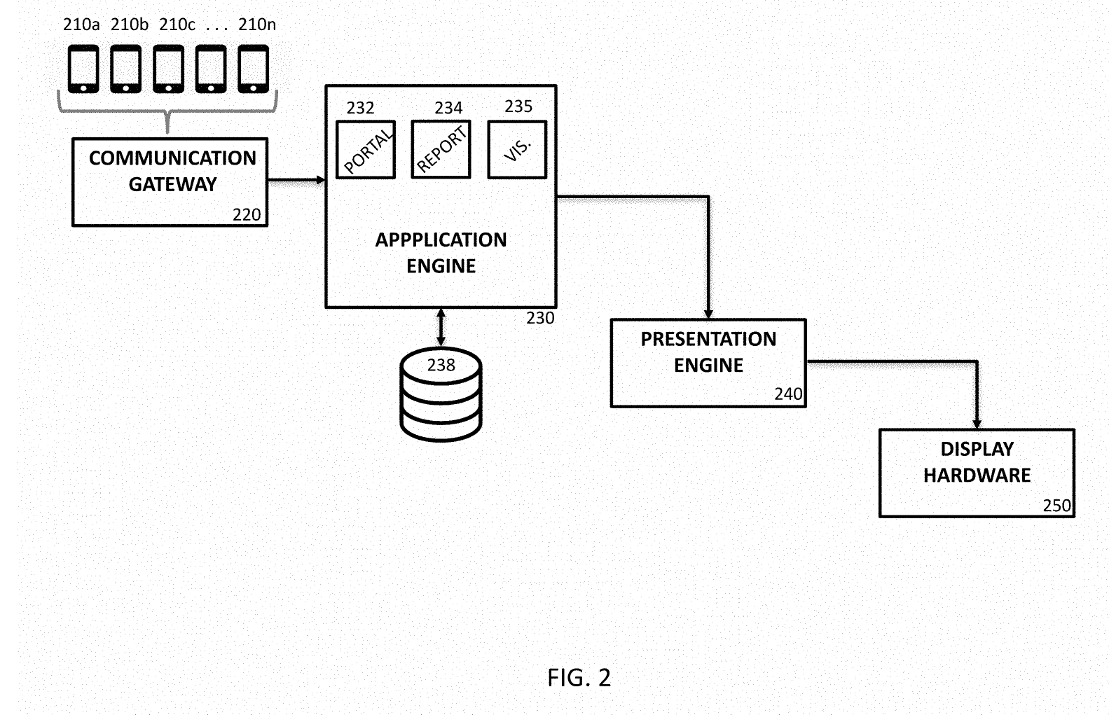

Referring to FIG. 2, a functional diagram is disclosed that describes the logical components of an exemplary system.

An array of participants 210a . . . 210n may be enabled to interact with the system via any number of computing devices. The specific number of participants will vary with different usages of the system and is limited only by the capability of the system to manage the load. In one embodiment, the participant array 210a . . . 210n may comprise users present at a venue where the system is being utilized, and communicating over a mobile computing device such as a smartphone or tablet computer. In embodiments, elements of the participant array may be communicating with the system remotely over a network or Internet connection such as in a webinar-style format, while others are physically present at the event venue.

In a preferred embodiment, users in the participant array 210a . . . 210n may communicate with the system by SMS messaging, though other communication methods are contemplated as coming within the scope of the invention, as will be discussed below. In embodiments, a communication gateway 220 may be provided in such an embodiment to receive SMS messages from the participant array 210a . . . 210n, process those incoming messages, and send data to the application engine 230 for further processing.

It has been found that SMS communication with the system is preferable since text messaging is pervasive, familiar, and generally requires that no special software be installed. However, communication via SMS messaging is one of many potential mechanisms for user engagement with the system. For example, SMS alternatives may include messaging via Apple iMessage, WhatsApp, Google Messenger, Google Allo, SnapChat, and BlackBerry Messenger, among many others. As an alternative to messaging, a dedicated mobile app could be provided for installation on user devices, and be configured to communicate with the system via a network. In still further embodiments, a web portal may be provided for access by the user on a mobile device. The system may also be configured to receive messages via e-mail and through social media.

In embodiments, responses may be submitted via SMS messaging sent from the participant's mobile computing device to a number that has been associated with the system. In embodiments, the number may be a general number for the system, or an SMS short code.

In embodiments using SMS messaging to receive user responses, a communication gateway 220 receives messages sent to the number associated with the system. Communication gateway 220 acts as a bridge between the plurality of mobile computing devices 210a . . . 210n operating on a cellular or wireless network and the system. Gateway 220 receives SMS messages from the plurality of mobile computing devices 210a . . . 210n and, after a series of processing steps, passes the content of the SMS message and related data to application engine 230.

In an embodiment, the participant array 210a . . . 210n may be in communication with an application engine 230 that is configured to manage and provide core system tasks. Examples of such system tasks include: (1) establishing and supporting a customer portal; (2) coordinating, triaging, and recording incoming SMS traffic; (3) managing interaction with system databases; (4) providing reporting functionality; and so on. In embodiments, application engine 230 may be a server computing device configured to run various software components that coordinate the interaction between the hardware elements of the system, including the participant array 210a . . . 210n.

Data received by the application engine may include the text of the message itself, and information about the sender. In embodiments, multiple data sources may be cross-referenced to generate a more expansive profile of the user. For example, a message from a participant will necessarily include the participant's phone number, along with the message body, a timestamp, and other information. By performing a lookup in a database that correlates mobile telephone numbers with information about those users, the system may be able to provide information such as the user's name, address or geographic location, age, and other demographic data that may be useful to the organizer. After an event, custom queries can be performed to view the comments and answers among different groups, e.g. answers among women aged 18-34 located in New York State.

Application engine 230 may further contain a number of modules that are devoted to carrying out specific system tasks to specific system tasks. For example, in the exemplary system of FIG. 2, application engine 230 comprises discrete modules devoted to supporting a customer portal 232, enabling reporting and analytics 234, and formulating the visualization and presentation of user comments 236. It will be appreciated by those of skill in the art that the application engine 230 is not necessarily physically divided into modules and that these divisions may be logical in nature. For example, separate software modules operating on a single application server, operating under the direction of a single control, may function as the application engine 230.

Application engine 230 may be dedicated or virtual. Embodiments of the invention have been implemented using the Heroku Platform-as-a-Service (PaaS). Such a PaaS may be used to run any portion of the system application software, or the entire platform.

A database 238 may be coupled to application engine 230 for storing data related to system operation. In embodiments, a document-oriented model is used to provide flexibility in data modeling and reduce system downtime.

In embodiments, a database of registered or prior users may be maintained so that data concerning an individual's participation may be logged over time. Returning users may be provided with a personalized greeting or acknowledgement of their status as a returning user. Database 238 may also store session-based data. For example, information related to each session may be recorded, including the subject master, specific questions and response, individual user answers, and related data. Database 238 may be configured to store media assets embedded with user responses such as image, sound, and video data.

In addition to media assets, visualization styles, and information related to the display of information, database 238 may also store information related to the content of the questions and answers, user information, and metrics such as response rate, response length, and so forth. These metrics may be aggregated and analyzed by reporting module 234 to provide customers with detailed data related to the level of user engagement at the event, along with information about the users.

The user's comment data, along with any relevant multimedia, may then by passed to presentation engine 240, which manages incoming content and determines, based on the customer's settings, what information will be presented on the presentation screen, in what order, for how long, and so forth. The presentation data is then passed to display hardware 250 for display at the venue.

In embodiments, application engine 230 comprises a user portal 232. To initiate a presentation session, the customer logs in to the system running on application engine 230 or, more specifically, portal module 232. As is described below, the user may be verified as an existing user and proceed with setting options for the event.

Once the session has been initiated and the session code generated, the system is ready to receive user input. In response to prompts on the main screen, session participants may submit responses from a computing device.

It has been found that the Programmable SMS platform provided by Twilio, Inc. is well suited for use with embodiments of the present invention. Similarly, various cloud-based storage services have been found to be compatible with the present invention including, for example, the Amazon Simple Storage Service (Amazon S3).

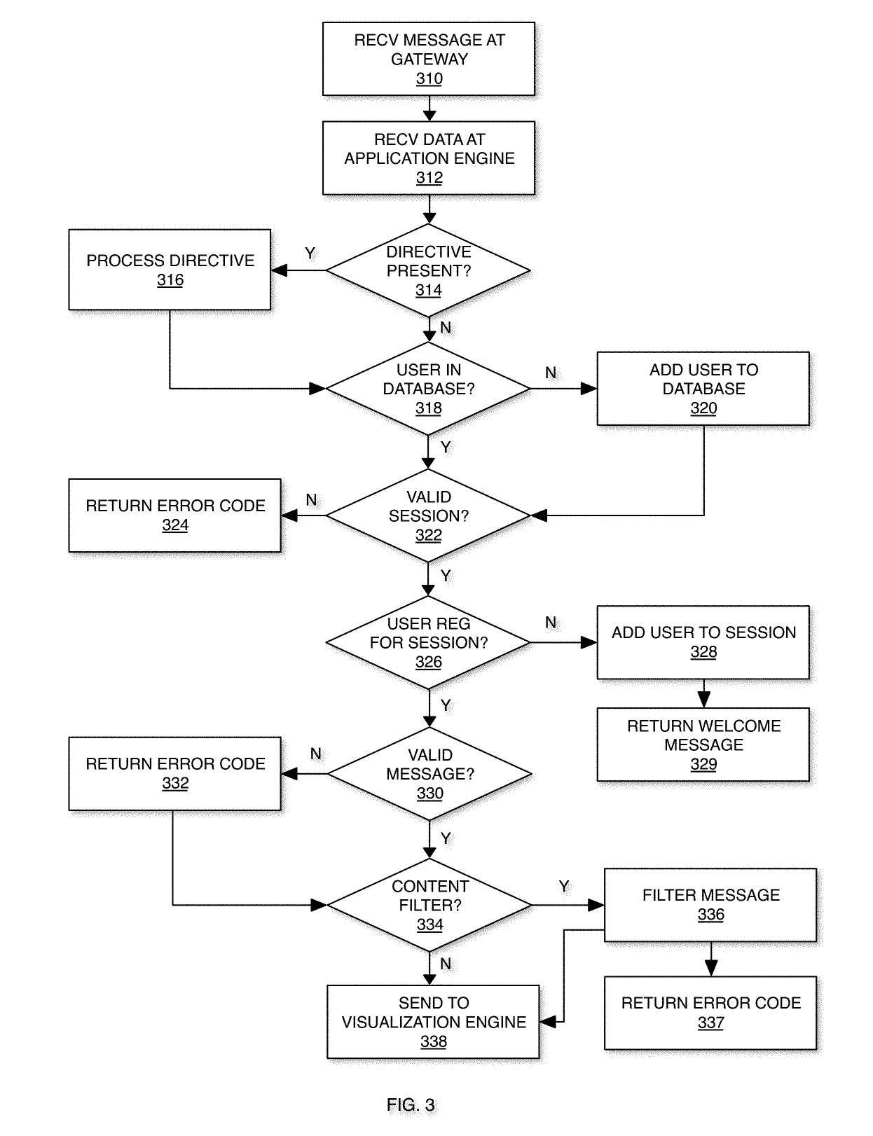

FIG. 3 shows the series of steps used to process incoming SMS messages in embodiments of the invention. Incoming SMS messages are received from wireless carriers by the communication gateway (310), which may receive the text message data and perform initial processing tasks including correlating the message data and sender phone number with identifying information to form a user profile. A data packet containing this information is then sent to an application engine (312), which manages filtering, error-checking, record-keeping, and coordination with a visualization engine.

Incoming message data is subjected to a series of checks and filters to confirm that the message data is valid and authorized to be displayed on the display hardware at the event. At step (314), application engine text associated with the message to determine whether the message contains a directive to the system, as opposed to a response for transmission to the display hardware. Example directives include STOP (indicating that the user wishes to stop receiving communications from the system), and HELP (indicating that the user requires assistance). If application engine detects (314) a directive, processing of the message halts and the sequence associated with the directive is followed (316). For example, an exemplary HELP sequence may include returning a message with available commands, or providing a link to online help. A STOP sequence may terminate all SMS communication with the user's phone number for that session.

Upon receiving a message from communication gateway, software running on application engine may verify (318) whether the user is listed in the user database. In embodiments, databases may be maintained of users that have engaged with the system over time to develop rich user profiles that provide information not only on responses, but demographic and other socioeconomic data. If the user is not identified in the user database, an entry is created (320) that may include this information.

A determination (322) may then be made as to whether the session is valid or remains valid. Each session may be associated with a session code. For users engaging the system for the first time in a session, the message will contain the session code that at (322) may be checked against the database to determine whether it is associated with an active session or whether an error message should be returned (324).

Assuming that the session is valid, a determination may be made (326) whether the user has registered for the particular session. After the initial setup message from the user, and system response, the user may be enabled to simply sent a text message to the specified number, without further registration or verification. To accomplish that ease of use, a user's mobile number may be associated with the particular session in the session database. Step (326) determines whether such an association has been made. If yes, processing of the message may continue, and if no, the user is added and any required compliance or regulatory messages are sent to the user. A log is made in the session database and the user is bound to this particular session. Future messages from this user to the given short code will default to this particular session. In embodiments, the message sent to new users may be customized by the customer or presenter in the settings section of the portal.

Validity of the message may be evaluated (330) and error checking may be conducted to verify that the message contains valid data. Messages not containing text data, for example, may be filtered at this step. Messages comprising a substantial portion of non-alphanumeric characters might likewise be filtered. Depending on user settings, filtering may be performed on message data that falls outside a predetermined specification. For example, at a conference in Rome, a host may only want to enable messages in Italian and English. At a product launch in Tel Aviv, the characters in the Hebrew alphabet would be expected, but those same characters might indicate an error condition in other regions. A host may wish to enable emoji for some audiences, but not others. If the message fails the verification stage, an error code (332) may be returned to the sender, and processing of that message halts.

A content filtering step (334) may screen the message for profanity, hate speech, epithets, and any other content that may be objectionable. In embodiments, screening may be performed for messages that are derogatory to the presenter or presenting company, or even those that mention, for example, competitors. If the content filter is triggered, the message moves to processing (336) where it is handled according to options set by the user. For example, the message may be blocked entirely, the user may be blocked, or the objectionable content may be blocked with the remainder passing through. A message may with one light obscenity may thus be handled differently than a message containing deeply offensive language or language impacting the presenter. In some embodiments, a message that triggers the content filter (334) may thus still be processed (338) by visualization engine in a modified form, or an error code (337) may be returned. The nature of the content and options set by the user may determine how the message is processed.

Embodiments of the system may provide different actions to customers for messages that have been flagged as containing problem content. For example, a customer may elect to have all messages containing problem content blocked, and a warning message sent back to the sender. Alternatively, the customer may elect to review flagged messages as they are generated and make decision in real time. Further still, the system may be set to send display the message, but with the problem portion obscured with “$#%@&” or the like. It will be appreciated by those of skill in the art that innumerable variations of these policies may be implemented.

In embodiments, the content filter may be replaced or supplemented by live moderation in which user comments are screened in real time by an individual associated with the presenter approves or disapproves of each comment as it is submitted. Alternatively, a live screener may review only subset of user comments that have been flagged by the automated content filter. Additionally, content that is flagged during the operation of the system may be dynamically added to the content blacklist.

Having verified the user and session association, and that the content blacklist has not been triggered, the message may be saved in the response database where it can be accessed by the visualization engine for integration into the live display.

In embodiments, a dynamic image function may be provided in which the system gathers image data based upon the content of a message. For example, if a response were to include a product SKU, the dynamic image subsystem would retrieve an image of the product from an online or local source. Embodiments of the invention have been used with the Bing Image Search API. If an associated image is found, it is saved in the database along with the message. Otherwise, no image value is saved with the message, and a default system-wide image is shown on the shared screen.

Alternatively, users may have the option to submit images directly using an MMS message. The image data may be held in the database record with the other message attributes.

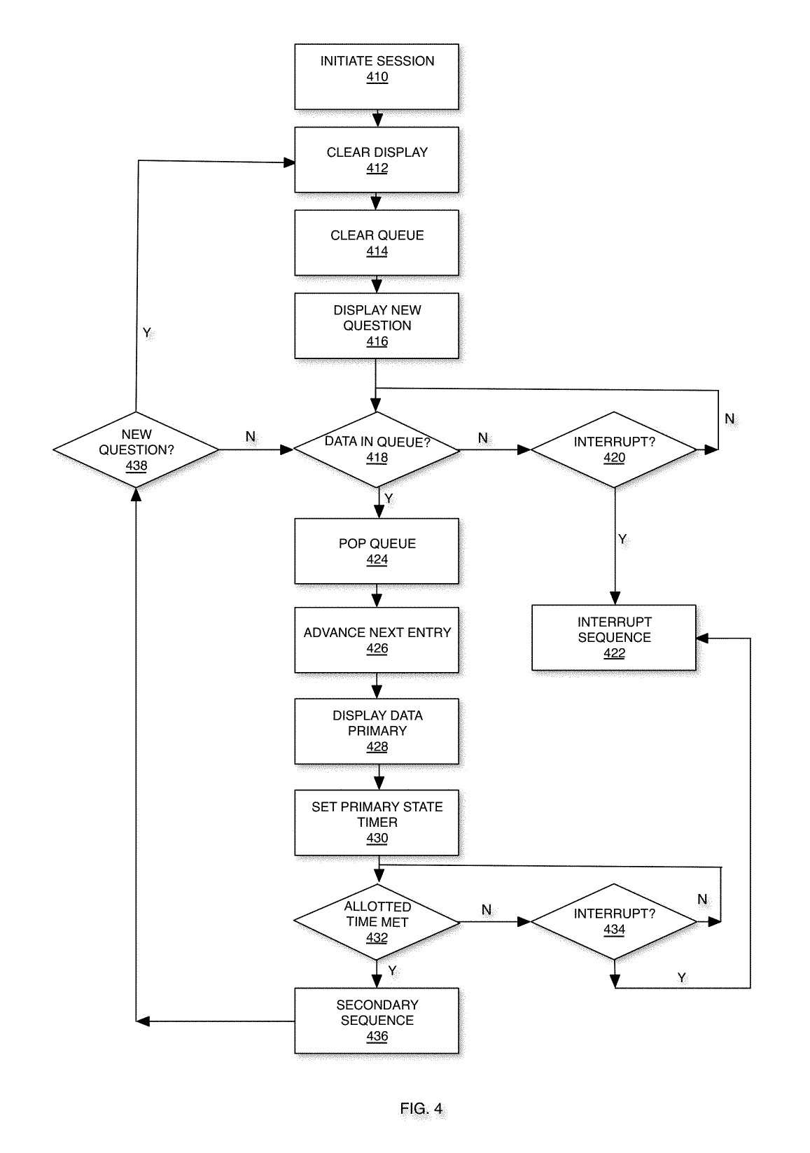

FIG. 4 describes an exemplary process for receiving user response data and generating visualizations for presentation to audience members.

One user data has been processed, system components prepare the data to be displayed, taking into consideration customer settings and preferences, and other incoming user data.

The visualization module commences (410) with an initiate session that may initialize system variables, load visualization templates and media, initialize display hardware, and initialize perform diagnostics. In an exemplary use case, a display may comprise a single monitor or projection at a venue, along with multiple remote displays interconnected via a network. The display hardware may be cleared (412) of any user data, which may be less of a concern during an initialization step, but more of a concern during repeated question and answer sessions, and may operate as an error control.

In embodiments, user response data may be stored in a queue data structure where the first entry in the queue is the first out of the queue, to be shown on the display. It will be appreciated that any number of data structures may be utilized to store message data, included stacks, weighted trees, priority queues, graphs, and the like. In embodiments, queue may be an array of references to documents in a database.

System display queue may be provided integrally with either the application engine generally or visualization engine specifically, and may be accessible by multiple system modules. For example, referring to FIG. 3, filtered message data may be sent (338) directly to a visualization engine that manages the queue. Alternatively, the queued message data could be administered from the application engine in communication with the gateway and visualization module.

In embodiments, a queue manager may be employed to maintain the integrity of the queue by controlling access to the data structure, performing push operations to add data in response to user requests, and performing pop operations to remove data in response to user requests. Isolating the queue structure behind a dedicated management module can reduce the risk of conflicts or errors in data.

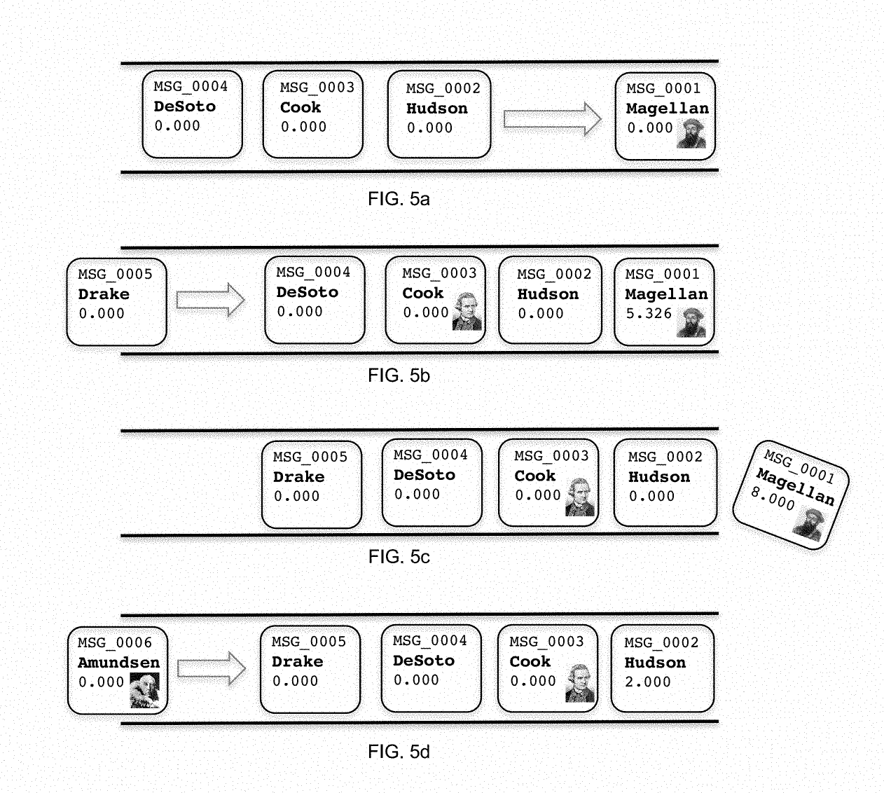

In embodiments, queue comprises a data structure store on any storage medium, whether volatile or non-volatile, and may consist of a sequential list of data objects, each of which contain information relative to a single user response. FIG. 5 shows an exemplary queue for storing user responses to the question: “Who do is the greatest explorer of the past 1,000 years?” FIG. 5a shows the queue as user responses arrive in the form of data objects containing: (1) a unique message identifier (e.g., “MSG_0001” or “581898124eede40010f561ce”); (2) the response (e.g., “Magellan”); (3) and a field indicating the number of seconds that the message text has been featured on the display. If enabled, the data object may also include an image associated with the response. As is discussed below, visualizations of user message data may feature or highlight incoming messages for a predetermined interval, making the total elapsed time in the that state relevant to processing of messages.

Moving to the next state, FIG. 5b, MSG_0001 (“Magellan”) has been on-screen for a total of 5.326 seconds since the past state, and a new entry has arrived, namely, “MSG_0005” with a vote for Sir Francis Drake, which as the most recent to arrive, takes its place at the rear of the queue.

In FIG. 5c, which occurs 2.674 seconds later, MSG_0001 has reached the maximum time allotted as the primary response, and is popped from the queue. FIG. 5d shows the following state 2.000 seconds later with MSG_0002 (“Hudson”) having been promoted to the primary response, with a new user response for Roald Amundsen (“MSG_0006”) having entered the queue.

Referring again to FIG. 4, since the system is initiating a new session or new question, the display is cleared (412), and the queue is emptied (414). Any entries in the queue at this point would likely relate to a prior session or question and are not responsive to the current question. The new question is then displayed (416) on the display hardware.

In embodiments, the customer and presenter has now posited a question or poll to the audience and provided a means for response on-screen. Expecting user responses, the system checks (418) the queue for data in the form of one or more user responses. In that case, interrupt sequence (422) would direct that the screen be cleared and message processing resumed. Alternatively, with moderation or prioritization features enabled, a specific user response may be advanced to the front.

The term “poll” is user herein for brevity and it will be appreciated to those of skill in the art that the present invention is suitable for use with any exchange of information between presenter and audience and is not limited to any particular format. For example, embodiments of the invention have been utilized with polls, multiple-choice questions, surveys, brainstorming sessions, and the like.

If no responses have yet come in, the system may check (420) for an interrupt signal, which may indicate any number of conditions. For example, the customer or presenter may have decided to skip the question altogether and move on to a different subject. In embodiments, a fast-forward and rewind function may be provided to customers or presenters so that the system may advance to the next question or poll may, or may go back to a prior question or poll. In embodiments, the responses on-screen may be cleared to provide room for a new set of user responses. The specifics of this feature may be customized in the settings portal.

If data is present in the queue, the first data object is popped (424) from the queue and the remaining entries are each advanced (426) one position. The message text associated with the popped data object is then presented on the display (428), and a timer is commenced (430).

In embodiments, each user response may be shown on screen on its own or in a “front and center” format where it is the featured data element on the display. Customers or presenters may be enabled to define settings that provide a set amount of time for each response to appear in this condition. If such a timer has been set, the system will check (432) whether the allotted time has been met. If not, the system may again check (434) for an interrupt signal and repeat the time check. Once the allotted time has elapsed, the user response may move (436) to a secondary sequence. As is discussed below, displaying a single response for a set time interval is one of numerous visualization options that are contemplated as coming within the scope of the invention. Secondary sequence 436 may add the current display object to whatever construct is on screen.

System processing may then check (438) whether a new question has been enabled by the customer or presenter. If so, the display and queue are again cleared (412, 414), the new questions are displayed, and the processing sequence starts anew. If a new question has not been enabled, the system reverts to the queue (418) to look for the next user response to display. If no data is present, the system idles as it checks (420) for interrupts and waits.

While embodiments of the invention are designed to provide customers with a pre-set, hands-off approach where minimal intervention is needed during the event, options are available for dynamic moderation and curation of user responses.

If moderation is turned on by the user for a session, any saved incoming messages will, by default will not show on the front-end visualization. The user can remove (blacklist a message) or accept (whitelist a message) via the moderation screen, where they see messages show up in real-time. If a message is whitelisted, the message is updated on the backend which then broadcasts a notification that the message has been modified. The front-end visualization listens for these notifications and displays any message that have been whitelisted.

In embodiments, visualizations may take a variety of formats from dynamic to static; two-dimensional to three-dimensional; and many others. It will be appreciated that there are innumerable variations on the visual formatting of user data presented.

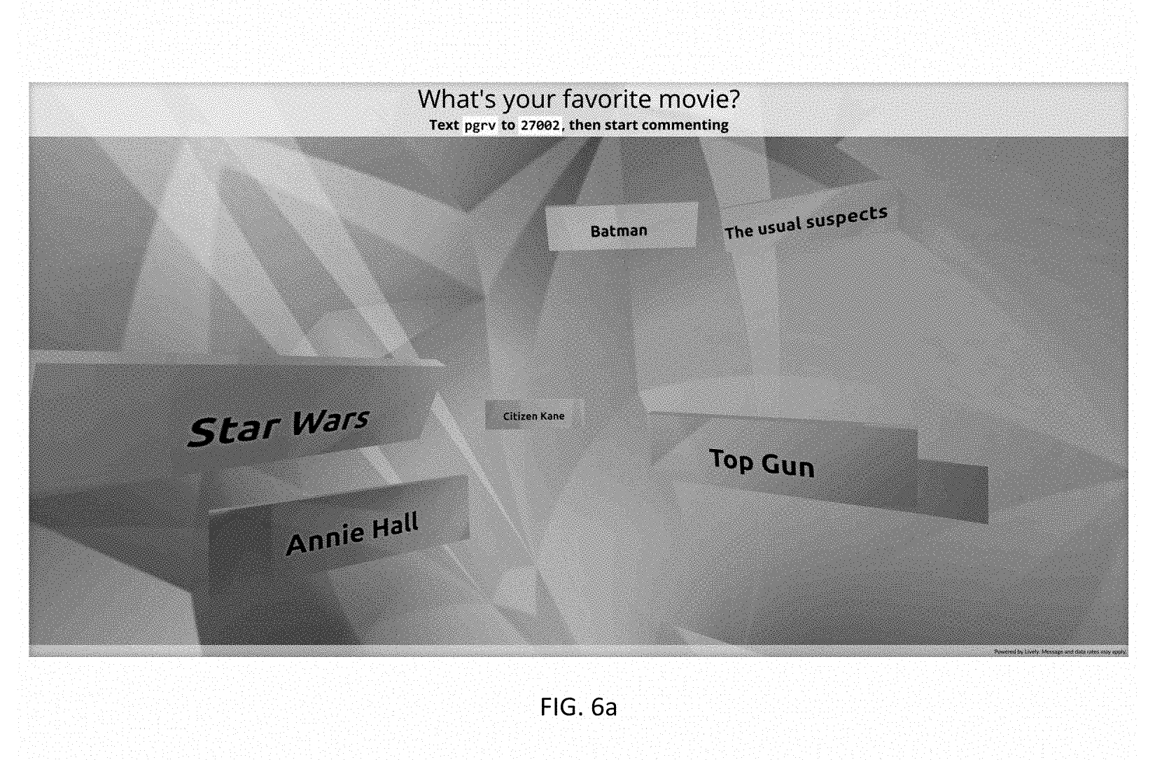

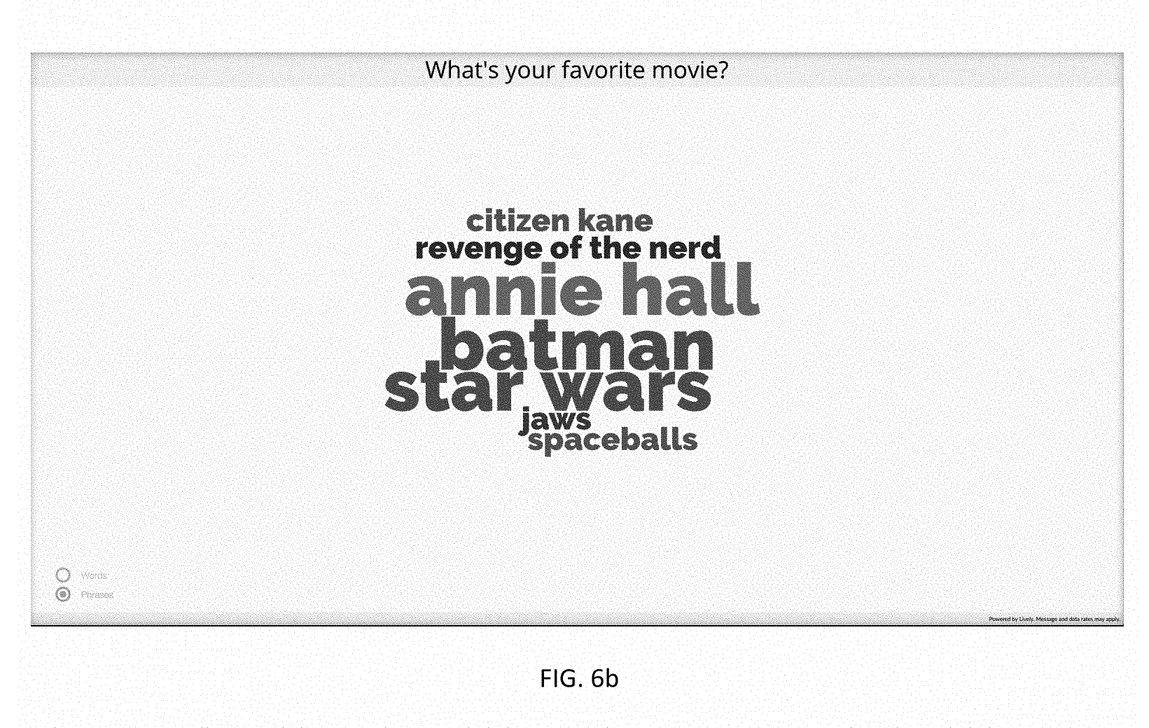

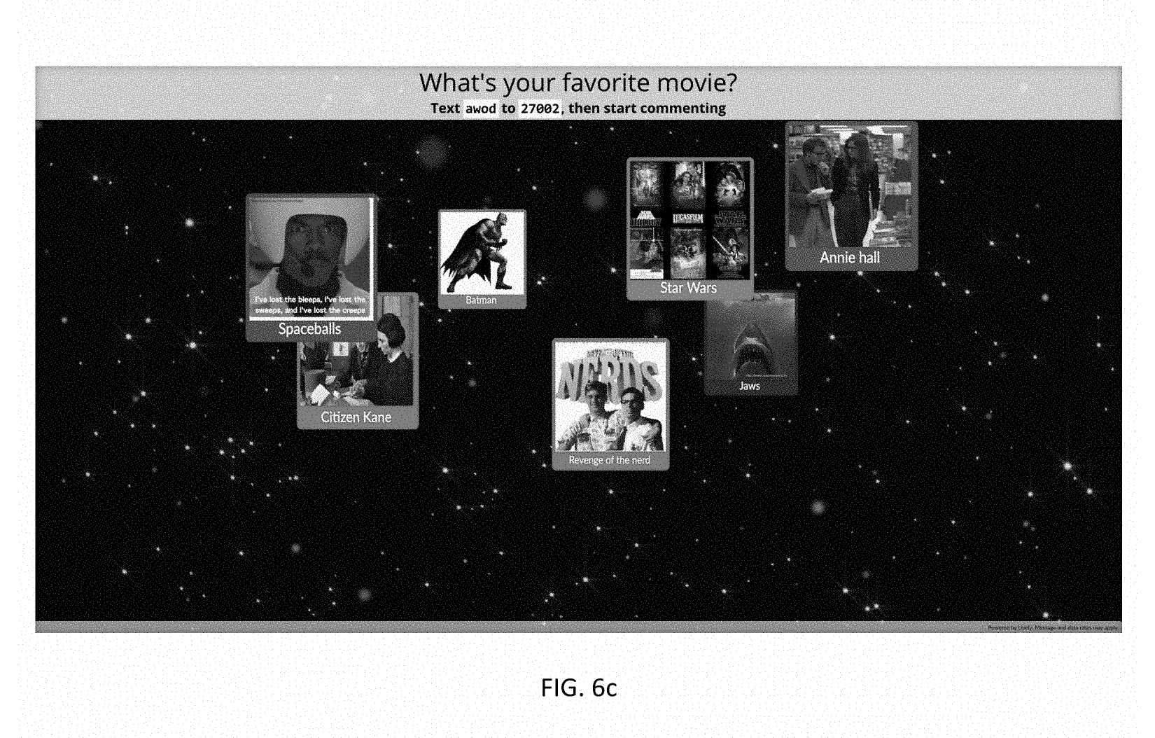

Referring to FIGS. 6a-6c, a series of sample visualizations are shown. In embodiments, the visualizations available to customers are highly customizable and may be tailored in the customer portal to meet the needs of the event.

In embodiments, system visualizations may include animation, the characteristics for which are set by the customer. For example, a particle system may be utilized to define how each text message will physically move on the screen. In such a configuration, each message is treated as a particle (or object), each with physical properties that have been pre-programmed When a new message is received, it animates into the front/center of the screen for several seconds (and is not part of the particle system) it appears in the middle of the screen. After this several second intro period, the message is added to the particle system and animates based on the physics of the particle system. The particles will repel each other if they get too close to prevent messages from overlapping. When particles repel each other, they start to travel in the opposite direction that they were previously heading, which creates more dynamic/spontaneous movement. FIG. 6a shows a static depiction of a particle system showing responses to the question, “What's your favorite movie?” The responses with a greater frequency of occurrence (Annie Hall, Batman, and Star Wars) are shown larger than the remaining entries to visually summarize the leading responses from attendees.

In embodiments, a word cloud visualization format may be used. FIG. 6b shows such a configuration where user data is normalized, with the resulting summaries shown in a size relative to the frequency of that particular response.

In embodiments, three-dimensional animation may be utilized. Here, messages may be displayed as three-dimensional, rectangular, reflective boxes. The boxes in this configuration may be positioned within a larger three-dimensional cube that has a texture on each of the sides which are seamlessly stitched together, forming an illusion of infinite depth. The message boxes reflect any textures on the inside of the larger cube since if there were no textures on the large cube, the message boxes would not be visible.

In embodiments, images related to the user responses may be displayed alongside the response. FIG. 6c is one such example. Where the user entered “Jaws” as their favorite movie, an image from the movie poster is shown adjacent the response. Images may come from the user in the original text message, or may be harvested by an image subsystem.

Databases for use with the system may be implemented in any number of ways. Embodiments of the system have been implemented using the Mongo Lab Database-as-a-Service platform, as is discussed below.

In a preferred embodiment, system databases may be stored in a document-oriented-model, which is well-suited for managing semi-structured data. Each record and its associated data is conceptualized as a “document” and rather than a defined database schema, the database structure may vary.

A key advantage to a document-oriented model such as the MongoDB used in a preferred embodiment of the invention is the use of JavaScript Object Notation (JSON), a human-readable data-interchange format. JSON stores information related to a single object in a single instance in the database and simplifies mapping between the data and the application layer, and obviates the need for an object relational mapper, which can reduce performance.

In embodiments, all data stored in system databases may be stored in a JSON format. At a general level, JSON data representations are based upon objects, which model real-world objects such as, in embodiments of the present invention, a session, a poll, a response, a customer, and a user, among others. Objects comprise collections of unordered key/value pairs in which commas are used to separated key/value pairs, and brackets are used to define the object.

Exemplary data objects utilized with embodiments of the present invention are described below.

An instance of a session or hosted event may be represented by a SESSIONS object. Following a unique identifier that designates the session throughout the system, an instance of a SESSIONS object comprises three main elements: (1) theme; (2) settings; and (3) polls.

```
{
  ″_id″ : ObjectId(″581e4ce69efe570010d3dc9c″),
  ″theme″ : {
    ″name″ : ″Abstract 3D″,
    ″background″ : null,
    ″type″ : ″3d″,
    ″_id″ : ObjectId(″581e4d3b9efe570010d3dca5″),
    ″palette″ : [ ],
},
  ″settings″ : {
    ″logo″ : ″http://livelyevent.com/logo.png″,
    ″autoresponse_message″ : ″This is a demo.″,
    ″enable_analytics″ : true,
    ″autoplay″ : {
      ″enabled″ : true,
      ″duration″ : 5,
      ″duration_modifier″ : 60
    },
    ″dynamic_images″ : {
      ″enabled″ : false,
      ″provider″ : ″Bing″
    },
    ″filter_words″ : [ ]
  },
  ″is_active″ : true,
  ″phone_number″ : ″27002″,
  ″session_id″ : ″84eObDpDkwczVqN7gvmw″,
  ″short_id″ : ″learn″,
  ″updated″ : ISODate(″2016-11-13T16:54:06.262-05:00″),
  ″created″ : ISODate(″2016-11-05T16:19:34.229-05:00″),
  ″name″ : ″Site demo - 3D Animation″,
  ″audience″ : null,
  ″user_id″ : ″6qnDthbTuvEJYsBDqct7R3″,
  ″_v″ : 1,
  ″active_poll″ : ObjectId(″581e4cef9efe570010d3dc9f″),
  ″polls″ : [
    ObjectId(″581e4cef9efe570010d3dc9f″),
    ObjectId(″581e4d339efe570010d3dca0″)
  ]
}
```

The THEME object contains settings related to the display at the event venue, namely the background behind the visualizations, type of visualizations to be use, and the color pallet. The SETTINGS section describes the location of any customer logos or graphics to be displayed on the background, an auto response message, autoplay settings, and whether dynamic images are enabled. A list of custom filter words may also be included. These settings may be set by the customer during event setup, and may have default values pre-set for conditions for which the customer has no preference.

A poll section contains references to the various polls and poll questions that may be presented during an event. During an event, this section may be populated with instances of the poll object described below.

As shown above, in addition to the theme, settings, and polls sections, a SESSION object may also include data relative to the specific session. Key/value pairs may be provided for other attributes such as whether the session remains active, the phone number or short code associated with the session, the session code, date created and updated, and a code identifying the customer.

A POLL object may be used to store a poll question that is put to the audience. The poll section may identify a unique identifier for the poll, date that the poll was updated, date that the poll was created, the text of the poll question, and the types of permissible responses.

```
{
  ″_id″ : ObjectId(″57cf12e62f1825100087a655″),
  ″updated″ : ISODate(″2016-09-06T14:03:02.100-05:00″),
  ″created″ : ISODate(″2016-09-06T14:03:02.100-05:00″),
  ″text″ : ″What was your first concert?″,
  ″type″ : ″comment″,
  ″user_id″ : ″1IHsODJhsDGq8e92jQmaIs″,
  ″_v″ : 0
}
```

Responses to a question or poll may be stored in the RESPONSES object shown below. Basic information concerning the poll may be included such as user and session identifiers, and the number of responses. In embodiments, a HISTORY section contains an array of response objects, each containing data relevant to the response.

```
{
  ″_id″ : ObjectId(″581898124eede40010f561ce″),
  ″unique_responses″ : 1,
  ″user_id″ : ″6qnDthbTuvEJYsBDqct7R3″,
  ″short_id″ : ″pain1″,
  ″session_id″ : ″OR7X4vYWQliZEe6yZZbd″,
  ″history″ : [
      {
        ″responder″ : {
          ″created″ : ISODate(″2016-09-01T14:45:15.132″),
          ″updated″ : ISODate(″2016-11-01T08:43:14.224″),
          ″phone_number″ : ″+7451″,
          ″country″ : ″US″,
          ″city″ : ″SOUTH RICHMOND HILL″,
          ″state″ : ″NY″,
          ″zipcode″ : ″11435″,
          ″_v″ : 0,
          ″active_session″ : ″Q4launch″,
          ″analytics″ : {
              ″first_name″ : ″Boundless″,
              ″last_name″ : ″Markets″,
              ″name″ : ″Boundless Markets″,
              ″email″ : ″″,
              ″age″ : ″″,
              ″education″ : ″″,
              ″gender″ : ″″,
              ″high_net_worth″ : ″″,
              ″home_owner_status″ : ″″,
              ″household_income″ : ″″,
              ″length_of_residence″ : ″″,
              ″marital_status″ : ″″,
              ″market_value″ : ″″,
              ″occupation″ : ″″,
              ″presence_of_children″ : ″″,
            ″address″ : [ ],
              ″linked_emails″ : [ ]
          },
          ″_id″ : ObjectId(″57c8854b9d977a1000fa11dc″),
          ″is_blacklisted″ : false
        },
        ″poll″ : {
          ″updated″ : ISODate(″2016-11-01T08:43:14.221″),
          ″created″ : ISODate(″2016-11-01T08:27:10.090″),
          ″text″ : ″What brought you here today?″,
          ″type″ : ″comment″,
          ″_id″ : ObjectId(″58169bc92eabc30010d3c9da″)
        },
        ″message″ : ″Meeting smart people″,
        ″recieved″ : ISODate(″2016-11-01T08:27:10.061″),
        ″_id″ : ObjectId(″5818982e4eede40010f561d5″),
        ″is_whitelisted″ : true
      },
    {
        ″responder″ : {
          ″created″ : ISODate(″2016-09-01T14:45:15.132-05:00″),
          ″updated″ : ISODate(″2016-11-01T08:43:14.234-05:00″),
          ″phone_number″ : ″+7451″,
          ″country″ : ″US″,
          ″city″ : ″SOUTH RICHMOND HILL″,
          ″state″ : ″NY″,
          ″zipcode″ : ″11435″,
          ″_v″ : 0,
          ″active_session″ : ″pain1″,
          ″analytics″ : {
              ″first_name″ : ″Boundless″,
              ″last_name″ : ″Markets″,
              ″name″ : ″Boundless Markets″,
              ″email″ : ″″,
              ″age″ : ″″,
              ″education″ : ″″,
              ″gender″ : ″″,
              ″high_net_worth″ : ″″,
              ″home_owner_status″ : ″″,
              ″household_income″ : ″″,
              ″length_of_residence″ : ″″,
              ″marital_status″ : ″″,
              ″market_value″ : ″″,
              ″occupation″ : ″″,
              ″presence_of_children″ : ″″,
                ″address″ : [ ],
              ″linked_emails″ : [ ]
          },
          ″_id″ : ObjectId(″57c8854b9d977a1000fa11dc″),
          ″is_blacklisted″ : false
        },
        ″poll″ : {
          ″updated″ : ISODate(″2016-11-01T08:43:14.231″),
          ″created″ : ISODate(″2016-11-01T08:43:08.607″),
          ″text″ : ″What brought you here today?″,
          ″type″ : ″comment″,
          ″_id″ : ObjectId(″58169bc92eabc30010d3c9da″)
        },
        ″message″ : ″Learning new techniques″,
        ″recieved″ : ISODate(″2016-11-01T08:43:08.564″),
        ″_id″ : ObjectId(″58189bec4eede40010f56290″),
        ″is_whitelisted″ : true
      }
}
```

An instance of a RESPONSE may contain basic information about the sender, including the phone number and location, and also more specific analytics data, if provided by the communication gateway or otherwise. Analytics data may include the name of the sender, e-mail address, age, education, gender, whether the individual is a so-called “high net worth individual”, whether the sender owns their own home, how long they have lived at that location, marital status, market value of the home, occupation, and whether there are children present in the household.

Following the responder information, the poll object may be included, along with the user's actual response to the question or poll, along with information concerning the time of the response.

In embodiments involving moderation of comments, an additional key/value pair may be used to indicate whether the comment has been whitelisted by the moderator and approved for publication.

### Display

Once the visualization has been generated, it is sent to the display hardware for view by the customer and users. The specific display apparatus utilized at an event may vary—from large format OLED monitors to digital projection to individual monitors to any sign or screen that displays a web page.

In a preferred embodiment, a web browser is directed to a specific URL associated with the session. Software running on the client computing device listens for a web socket message broadcast by the visualization server, which indicates that a new message has been received. The computing device then displays the message and associated content (e.g., text, dynamic images, etc.) on any displays associated with the computing device.

The web-based implementation for content display is only one example of displaying user content. In alternate environments, dedicated software may be employed.

The system, including software running on the client computer, may provide the customer with additional options over content on the display. Customers may be able to advance to the next question by pressing a key on their keyboard. When they do so, the next question they specified will appear—and all comments associated with the previous question will automatically disappear on the screen. This will provide a blank slate for comments and answers to the new question.

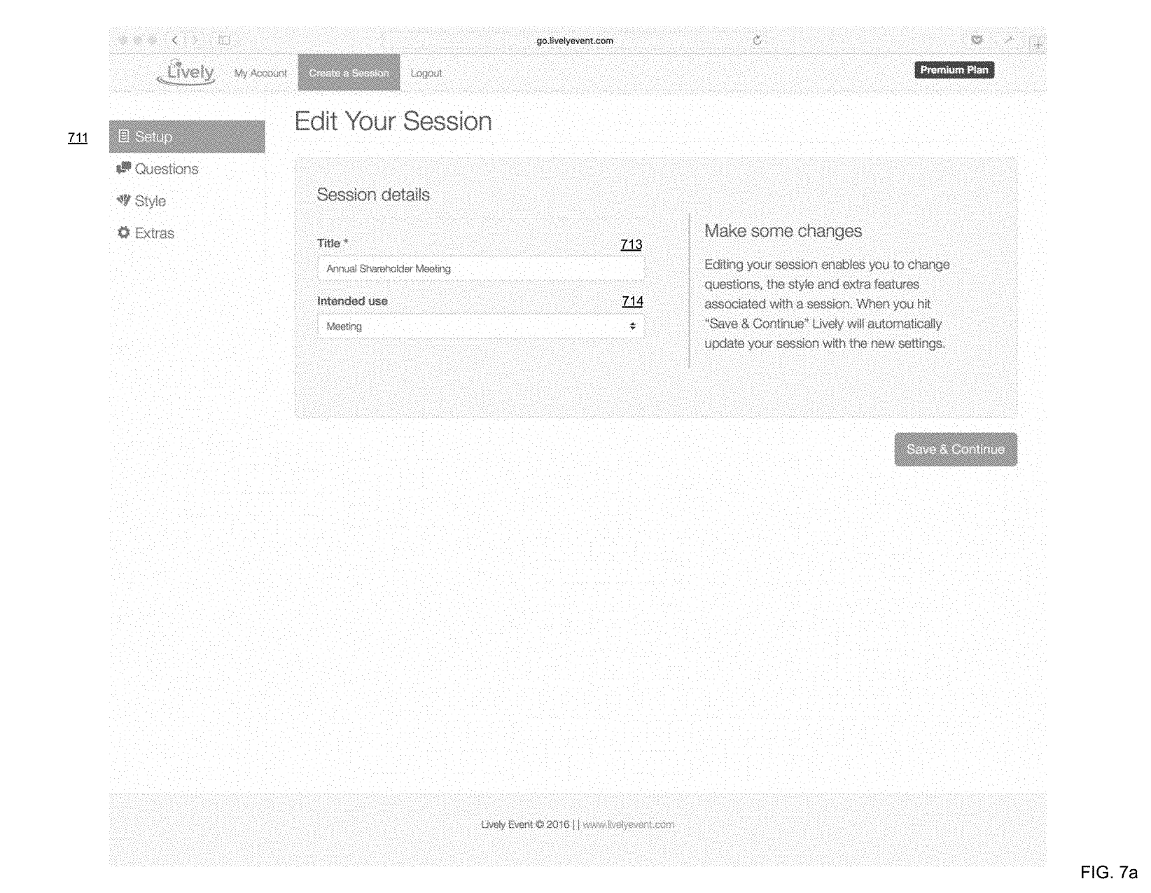

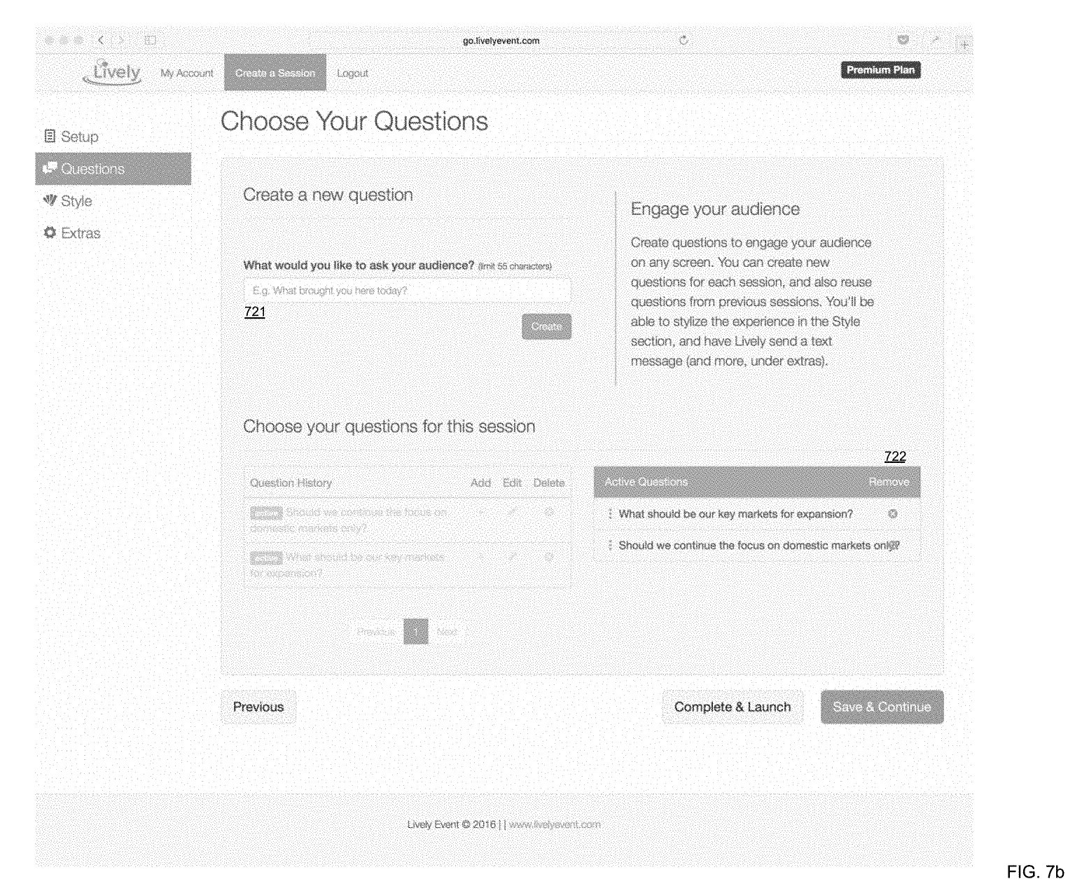

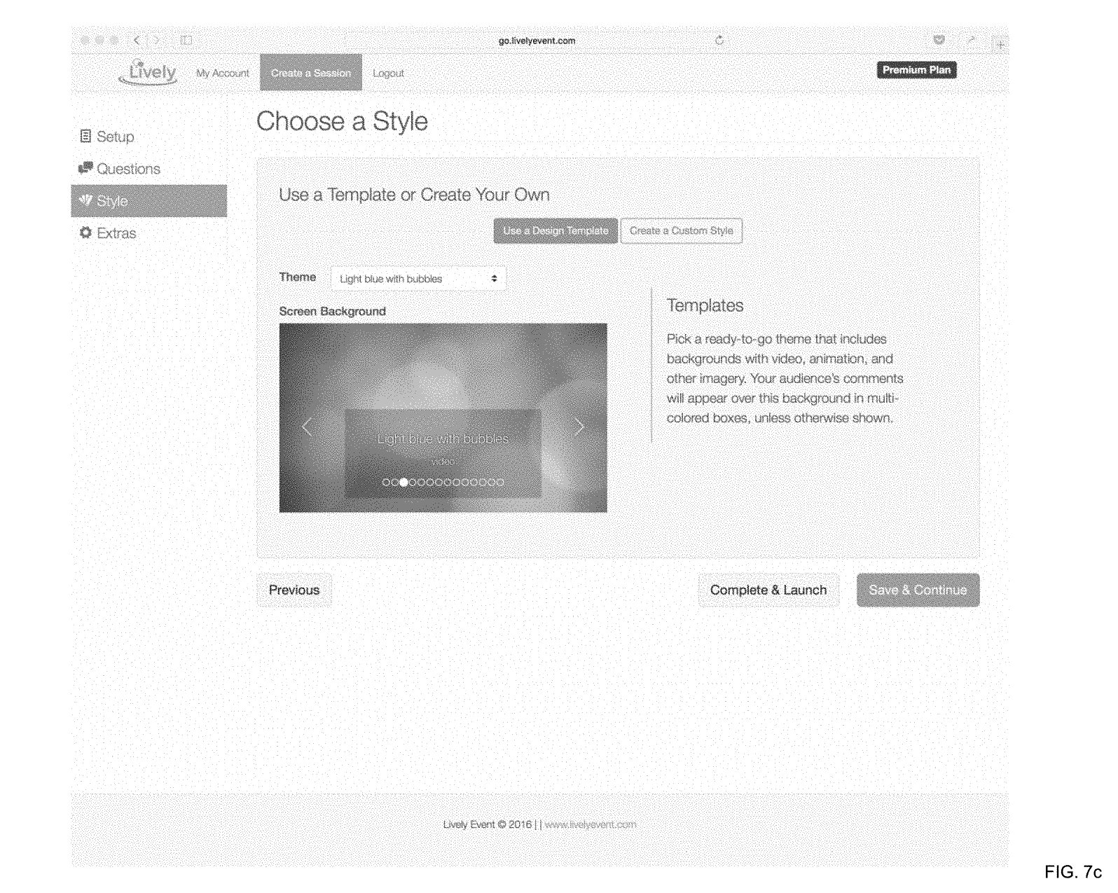

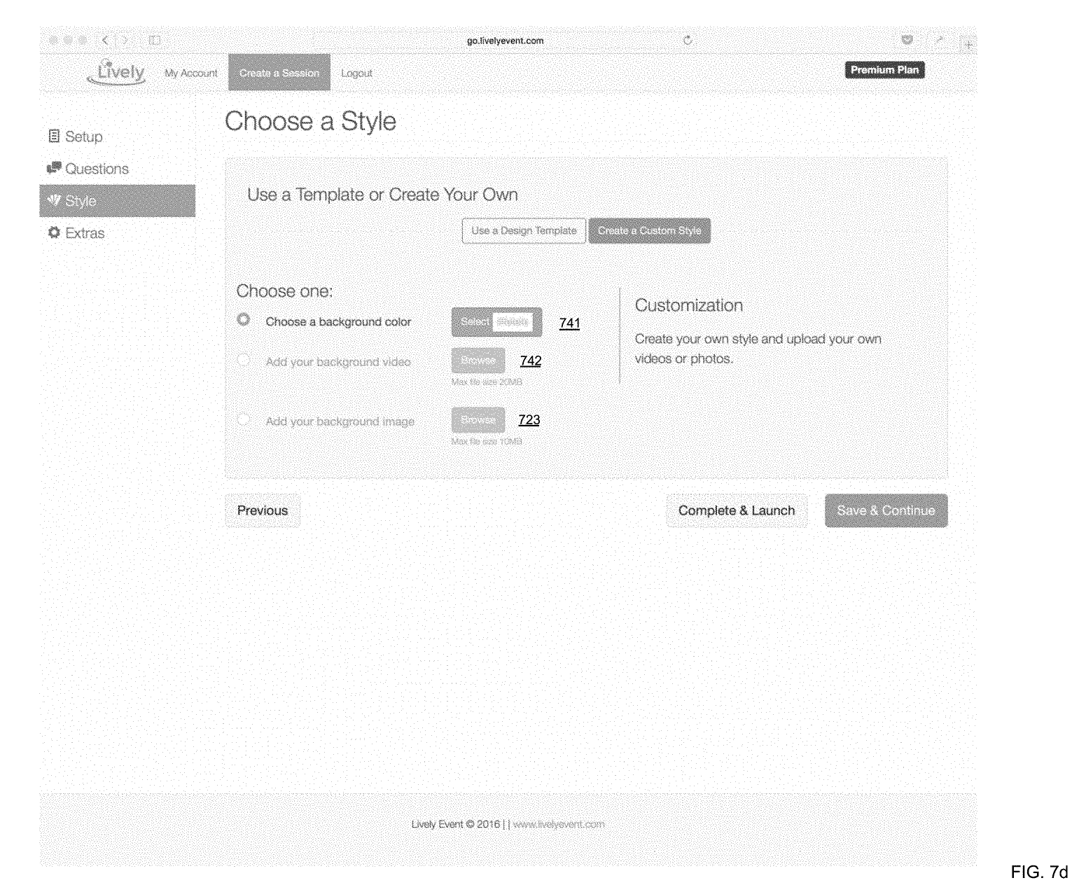

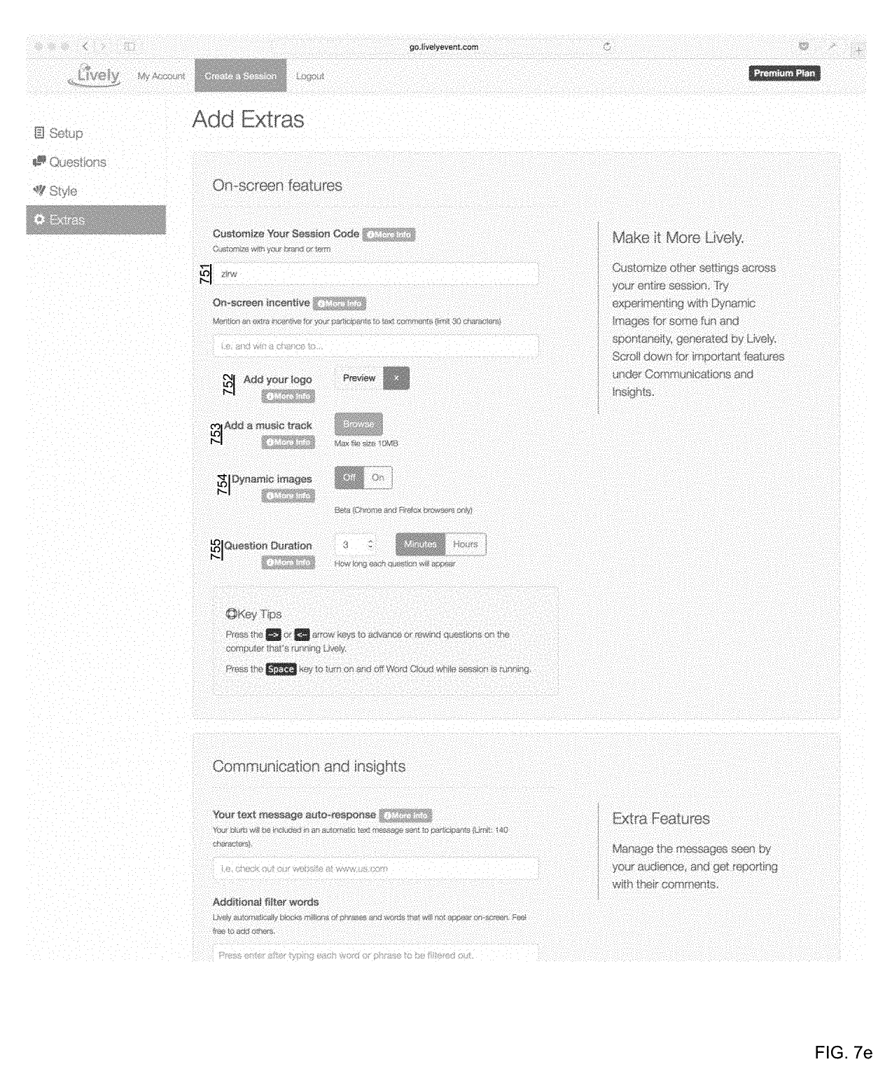

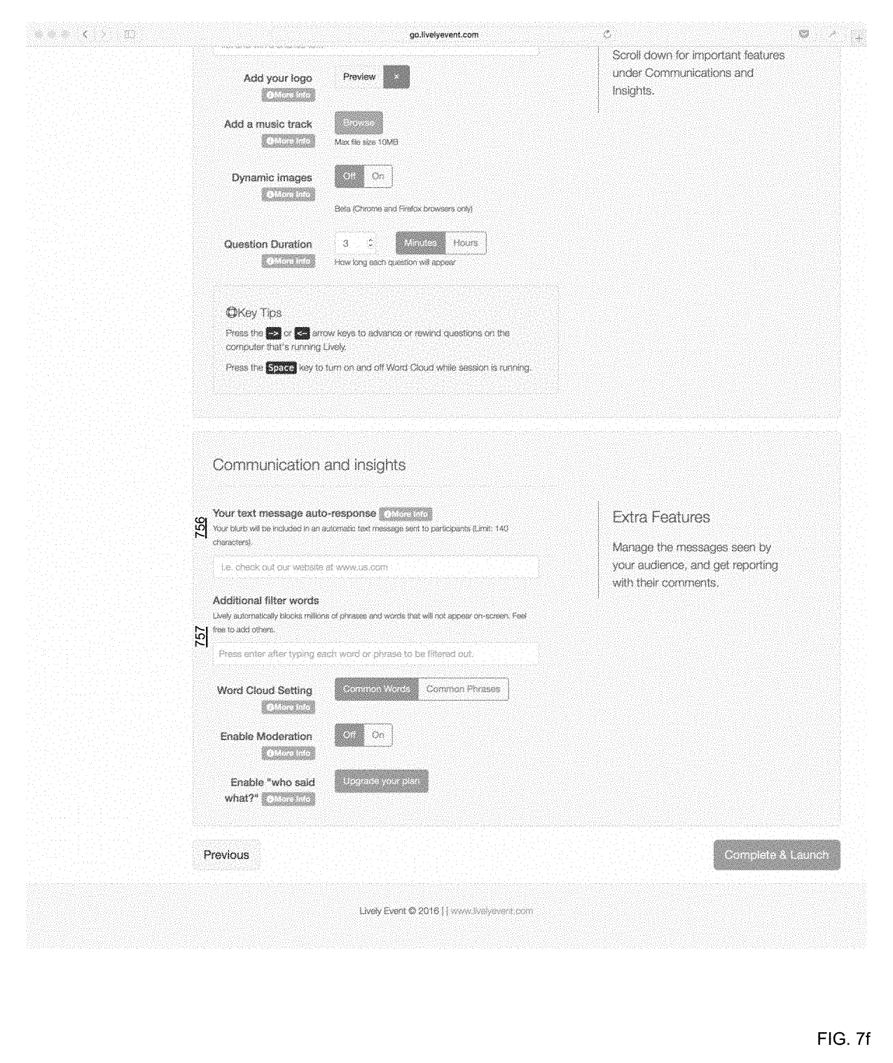

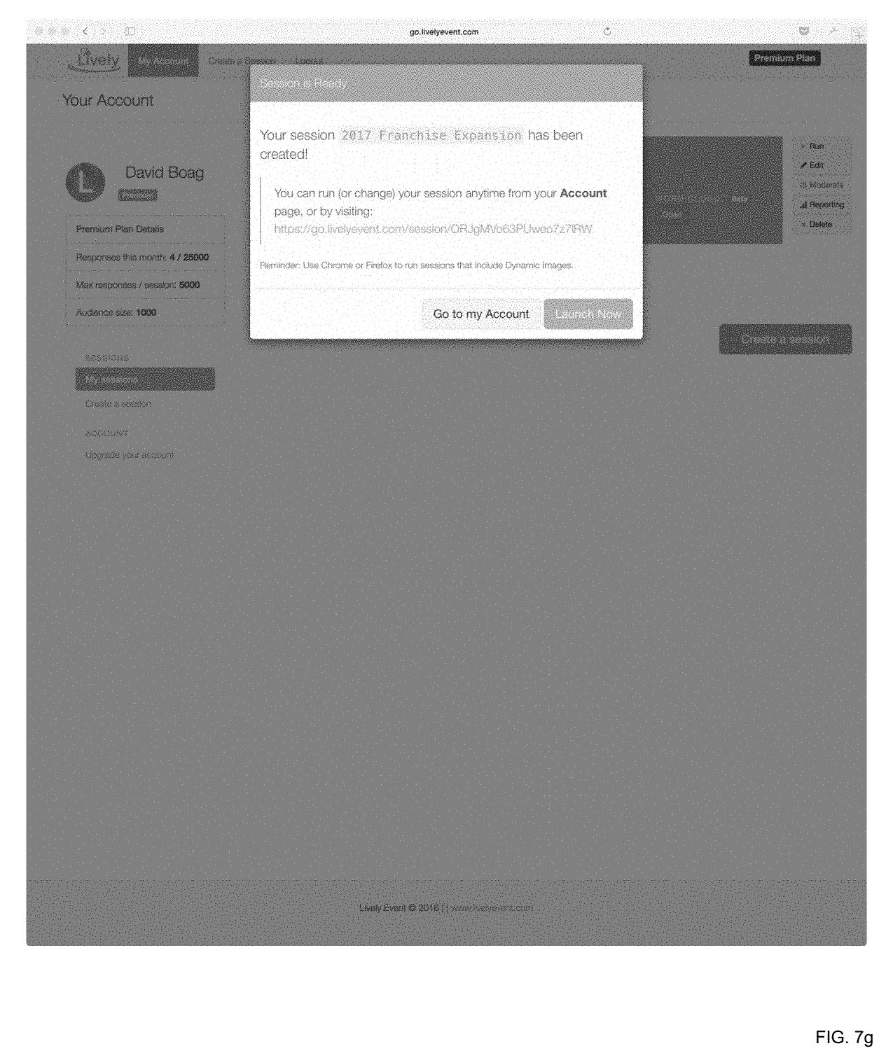

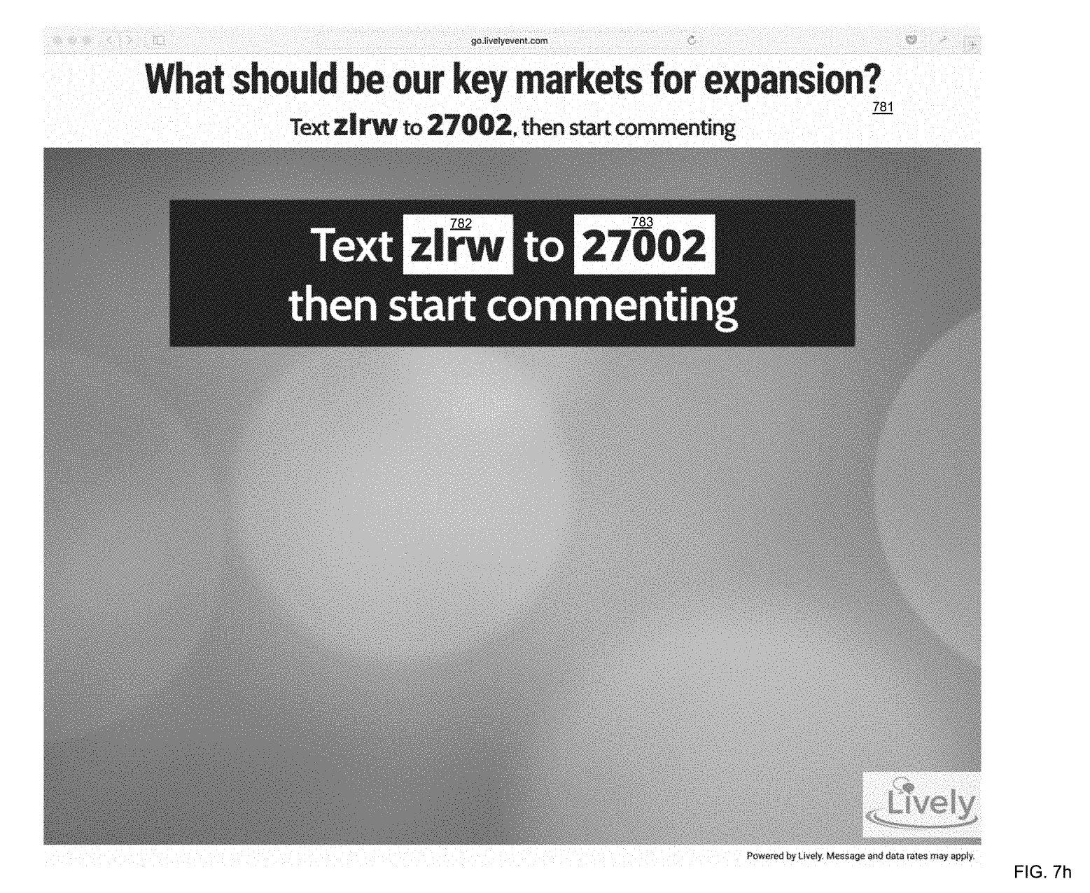

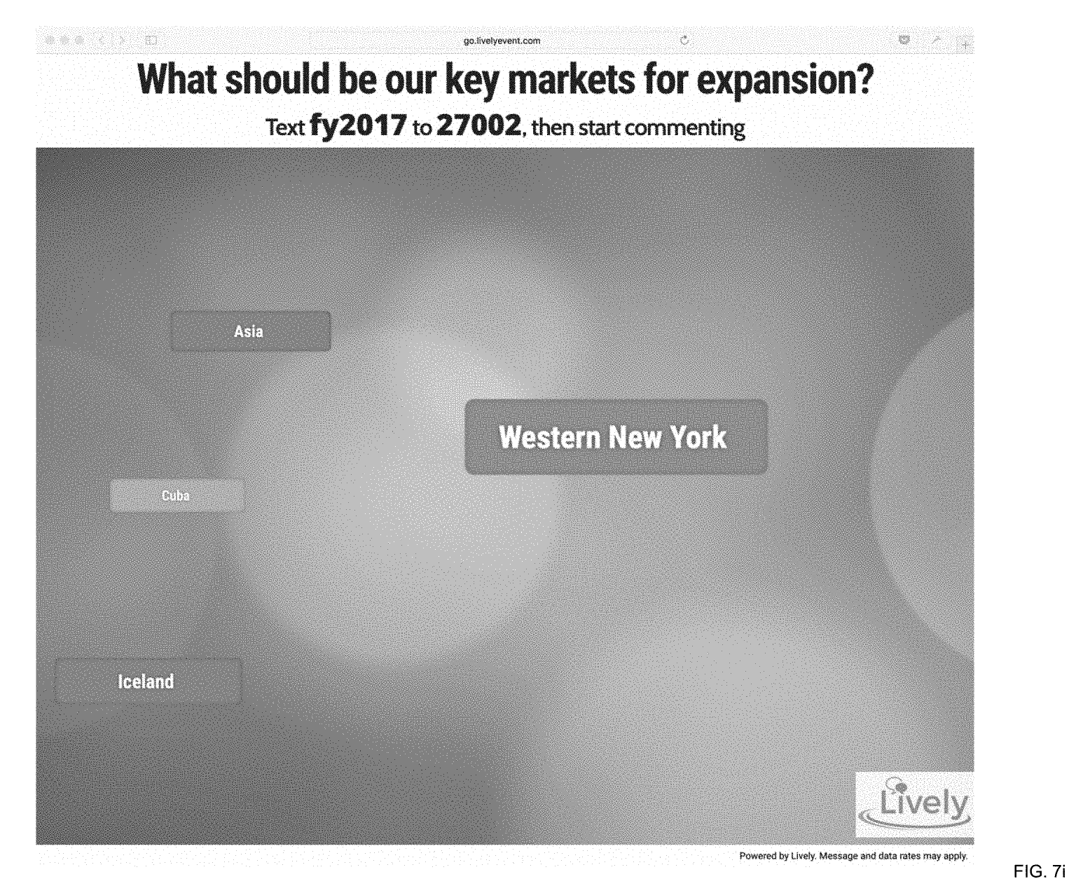

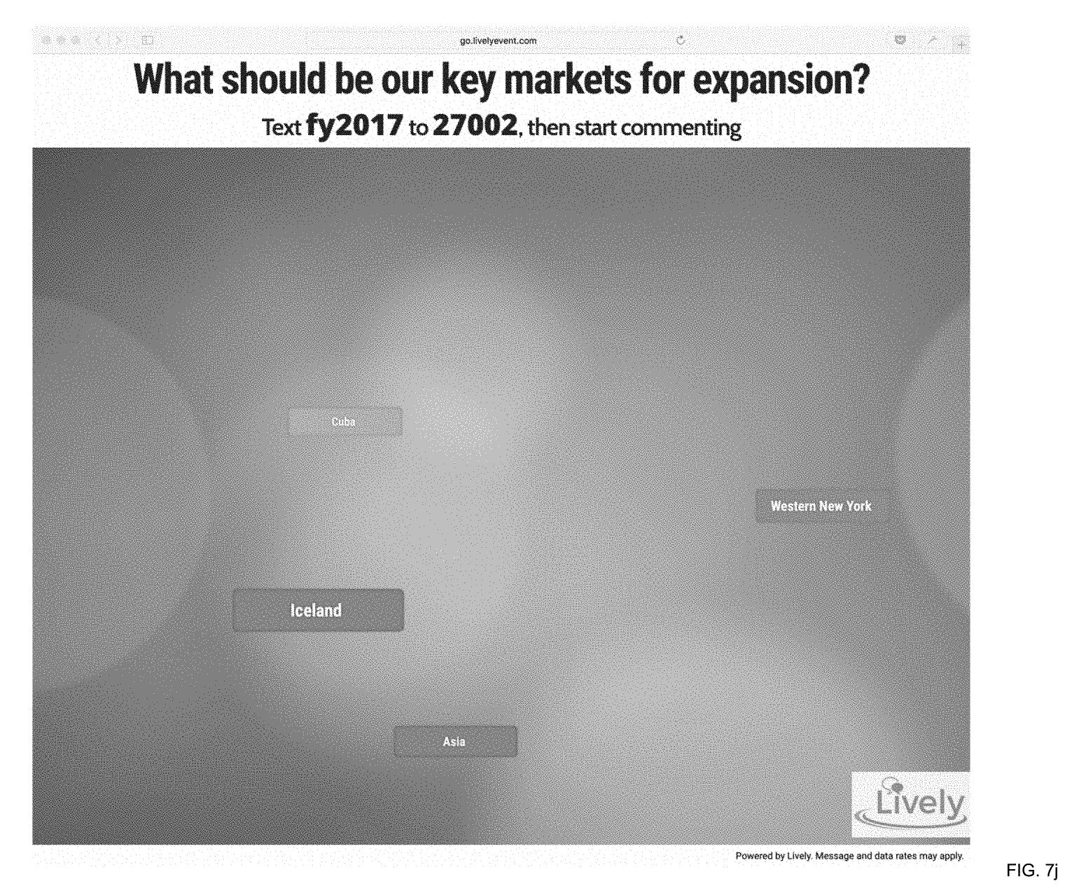

Referring to FIG. 7a-7j, a series of screenshots of the customer portal is shown, followed by a visualization example Customer portal may be implemented as a web-based application, or as a dedicated piece of software.

In an exemplary embodiment, an API such as that provided by Stormpath, handles registration, login, forgot password, password reset, verification flows for users, and also stores basic account and tier data for users.

FIG. 7a is a replica of a web page, in accordance with an embodiment of the invention, showing a sample customer portal after the customer's login credentials have been verified. The web page may provide account data such customer's service tier. If customer tiers are utilized, limits may be placed on the number of sessions per month, unique users, audience size per event, and the number of user responses. Where the customer stands in relation to these limits may be shown directly on the portal at 702.

An option is provided for a title (713), and also an intended use (714). An intended selection may be provided to preselect themes, visualizations, and other options that can vary from use to use. For example, a different option set may be desirable for a corporate event than an educational one.

FIG. 7b is a replica of a web page, in accordance with an embodiment of the invention, showing the page after FIG. 7a, after the user has selected the “Save & Continue” button. FIG. 7b shows the portal area that enable customers to prepare audience questions and polls. The user is able to enter a question in the box (721), select the “Create” button, and the question is added to the system. The questions entered by the customer may be queue under the Active Questions list (732), and may be edited, deleted, or supplemented. In FIG. 7b, the questions for the pending session include: (1) “What should be our key markets for expansion?” and (2) “Should we continue the focus on domestic markets only?”

With the questions for the session in place, FIG. 7c is a replica of a web page, in accordance with an embodiment of the invention, showing the Choose a Style module in which the customer is able to define templates and styles for the visualization. FIG. 7c shows available design templates with pre-selected media, colors, textures, and movements. Design templates may be created by the user, provided by the system, or acquired from other users through exchanges or sale. Referring to FIG. 7d, the step of generating a custom style is shown, with options for background color (741), and the ability to upload a background video (742) or background image (743).

For certain tier levels, an Add Extras set of settings may be enabled, as is shown in FIG. 7e. A custom session code (751) may be selected by the user that participants will utilize to engage the system. Users attending a Lively product launch could be prompted to text “LIVELY” to the short code, rather than the default code. In embodiments, custom logos (752) and music tracks (753) may be provided by the customer, and additional settings options may be provided. Whether dynamic images are enabled (754) may be left to the user, determining whether an automated lookup is performed for images related to user responses. The duration of each question posed may also be set (755).

In embodiments, as shown in FIG. 7f, the user may be given the option (756) to define the initial auto-response to user submissions, providing an additional level of customization. Additional filter words may be defined (757) to supplement the existing filters in the event that there are specific words (e.g., competitors, negative nicknames for the product, etc.) that the customer wishes to avoid. How the word cloud clusters, whether moderation is enabled, and whether the “who said what” (described below) feature is enabled may be additional settings options.

Once the user sets the available options, a “Session is Ready” message may be generated as shown in FIG. 7g. The customer is provided with a link to the session, and the option to launch the session. At this stage, the user may elect to launch the session, or wait until the start of the event.

FIG. 7h is a replica of a web page, in accordance with an embodiment of the invention, showing the system upon launch, as would be visible at the event. The question or poll posed may be shown (781), and a session code (782) and communication link (783) may be provided. Users interested in responding to “What should be our key markets for expansion?” may then text the session code (fy2017) to the communication link for the session. After the link has been made between the user's telephone number and the session code, all further messages from that number will be sent to that session.

FIG. 7i shows a sample visualization as responses being to come in from users. Here, users have responded to the question with “Asia,” “Cuba,” “Iceland,” and “Western New York.” “Western New York” is shown approaching the center of the screen and larger than the other responses, indicating that it is the most recent submission. FIG. 7j shows the same visualization as “Western New York,” the most recent entry, begins to recede.

A reporting subsystem may be provided to gather data, analytics, and metrics related to users and user involvement and provide reporting options to the customer.

For example, a reporting subsystem may generate reports showing their questions and the associated comments from the audience, which may include the number of participants that answered, the total number of messages received, and zip codes of where participants live. These reports will include other presentations based on the data collected by the system, and other data provided by third parties, that are ingested into the system. Current implementations show the comments of specific people, demographic reporting, most frequently mentioned responses and more.

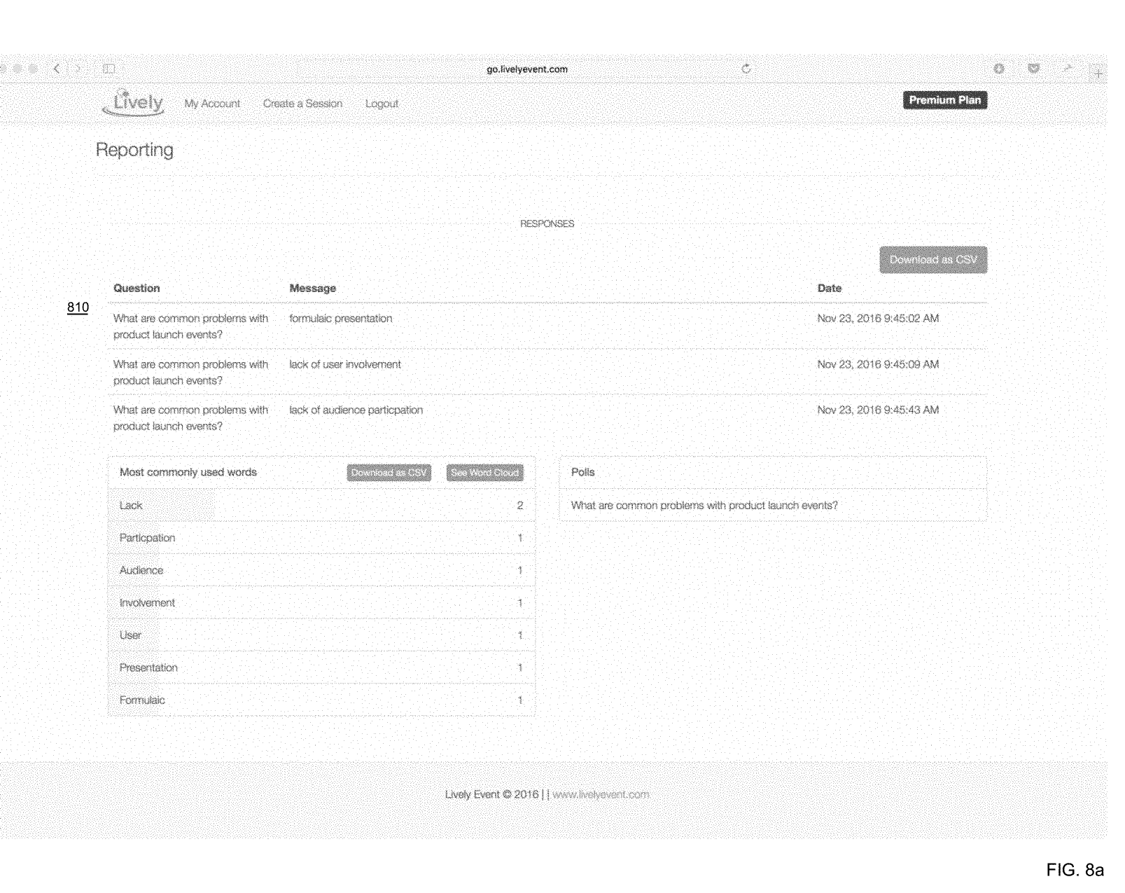

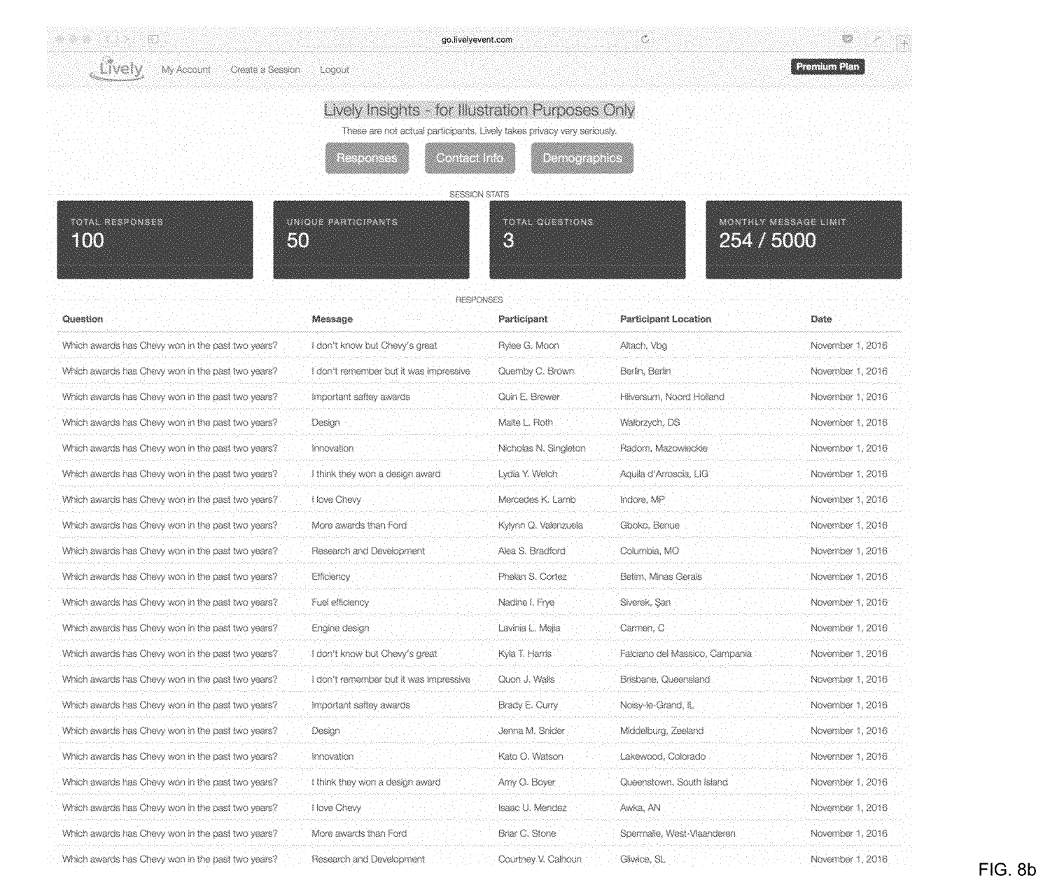

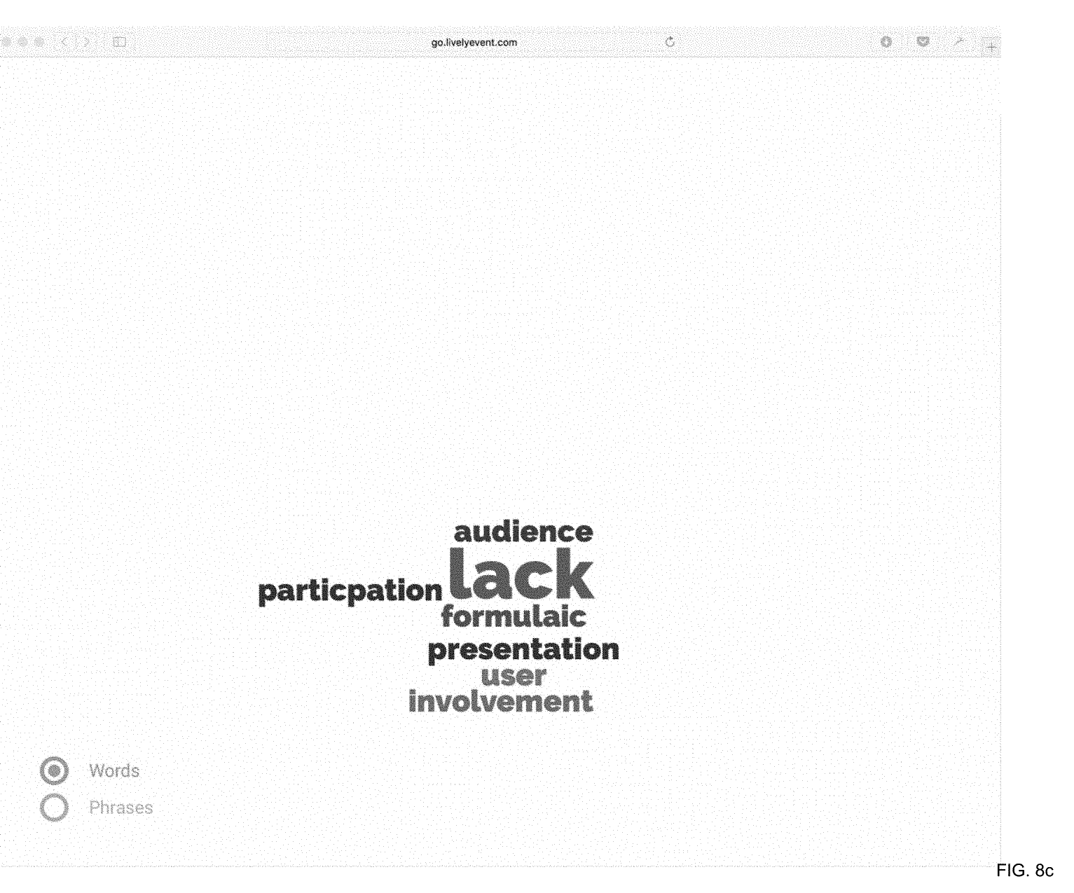

Referring to FIG. 8a, a sample reporting portal is shown. In embodiments, reporting may be associated with a single session, or may cover multiple sessions at once. In FIG. 8a, the results of a single session are shown. A list (810) of all questions and answers may be shown, which may be time-stamped and sortable. An export option (812) may be provided to export the data to a spreadsheet, database, or other software for further analysis. In embodiments, columns may be added or removed, and repositioned to meet the individual needs of the customer.

In embodiments, and as shown in FIG. 8b, customers of certain types of events may enable a “Who Said What” feature in which a user's identity is incorporated into the event record. Who Said What may utilize the user's telephone number and reference it against databases containing related data. In embodiments, the Who Said What feature may be limited to business events only and be disabled for events involving consumers. In embodiments, the most commonly used words may be presented as a list, or in a word cloud format as shown in FIG. 8c where the size of a word or phrase corresponds to the frequency of occurrence in the responses.

In embodiments, identifying information about the individual responder may be provided. For example, the phone number of the submitting user may be provided alongside the question and response. If other information about the user is available (e.g., name, location, device type), that information may be included in the FIG. 8b table.

In embodiments, this enhanced user identification and reporting may be enabled by cross-referencing different datasets to associate information with the mobile telephone number, either in real-time during the event or afterward. By using the mobile telephone number as a key to various interconnected datasets, the system may be able to provide information such as the user's name, address or geographic location, age, and other demographic data that may be useful to the organizer.

In embodiments, the reporting features shown in FIGS. 8a-8c may be modified depending on the subject matter of the event or the intended audience. For example, a consumer event open to the public may require privacy considerations different from a closed business session. Accordingly, in the consumer event, basic reporting may be enable to record responses, but without any other identifying information. The business event could be configured to record all information available.

As shown in FIG. 8c, a visual representation of the most commonly appearing words or phrases may be provided to provide the customer with an overview of the session.

It will be understood that there are numerous modifications of the illustrated embodiments described above which will be readily apparent to one skilled in the art, including any combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A system for receiving and displaying enhanced audience commentary or feedback comprising:
at least one display screen configured to display a destination code and a session code;
a communication gateway configured to receive at least one user data packet sent to the destination code by one of a plurality of computing devices;
an application engine coupled to the communication gateway and configured to receive the user data packet, perform one more lookups in a remote biographical data source, and create a processed data packet;
a database coupled to the application engine configured to store a plurality of processed data packets, each comprising: (a) a unique identifier; (b) user response data; and (c) user biographical data;
a visualization engine coupled to the database and configured to load the user response data of a processed data packet and coordinate the graphical display of the processed data packet on the display screen.

2. The system of claim 1 further comprising a reporting module coupled to said application engine and said database and configured to aggregate user response data and user biographical data and generate summary reports.

3. The system of claim 2 wherein said summary reports include: (a) the identity of the party that submitted the user response data; and (b) the content of the user response data.

4. The system of claim 2 wherein said summary reports include at least one of characteristic concerning the party that submitted the user response data, the characteristic being selected from the list of: geographic information, contact information, social media information, demographic information, financial information, and income.

5. The system of claim 1 wherein said visualization engine is further configured to display the user response data in a graphical format.

6. The system of claim 4 wherein said graphical format includes one of: animation, particle, word cloud, and front-and-center.

7. The system of claim 1 wherein the application engine is configured to permit the submission of a user data packet without prior registration.

8. The system of claim 1 further comprising a moderation module coupled to said visualization engine and configured to permit review of user response data prior to display on the display screen.

9. The system of claim 1 wherein said application engine is further configured to store image data as part of a user data packet for later display on the display screen.

10. The system of claim 9 wherein said image data is received by the communication gateway before transmission to the application gateway.

11. The system of claim 9 wherein said image data retrieved by a database lookup on an image library or remote data source before transmission to the application gateway.

12. A computer-implemented method for displaying enhanced audience commentary or feedback comprising:
providing a destination code and a session code to at least one user;
receiving, from a communication gateway, a user data packet comprising information to be displayed and a user identifier;
storing, in a database coupled to the communication gateway, the user data packet;
receiving, at an application engine, the user data packet and performing one or more lookups in a remote biographical data source to create a processed data packet;
storing the processed data packet in a database coupled to the application engine, said database configured to store a plurality of processed data packets, each comprising: (a) a unique identifier; (b) user response data; and (c) user biographical data;
receiving, at a visualization engine coupled to the database, the user response data associated with a processed data packet and coordinating the graphical display of the processed data packet on the display screen.

13. The system of claim 12 further comprising a reporting module coupled to said application engine and said database and configured to aggregate user response data and user biographical data and generate summary reports.

14. The system of claim 13 wherein said summary reports include: (a) the identity of the party that submitted the user response data; and (b) the content of the user response data.

15. The system of claim 13 wherein said summary reports include at least one of characteristic concerning the party that submitted the user response data, the characteristic being selected from the list of: geographic information, demographic information, financial information, and income.

16. The system of claim 12 wherein said visualization engine is further configured to display the user response data in a graphical format.

17. The system of claim 16 wherein said graphical format includes one of: animation, particle, word cloud, and front-and-center.

18. The system of claim 12 wherein the application engine is configured to permit the submission of a user data packet without prior registration.

19. The system of claim 12 further comprising a moderation module coupled to said visualization engine and configured to permit review of user response data prior to display on the display screen.

20. The system of claim 12 wherein said application engine is further configured to store image data as part of a user data packet for later display on the display screen.

21. The system of claim 20 wherein said image data is received by the communication gateway.

22. The system of claim 20 wherein said image data retrieved by a database lookup on a remote data source.
